(19) United States
(12) Patent Application Publication
(10) Pub. No.: US 2020/0151685 A1
(43) Pub. Date: May 14, 2020

(54) Platform for Service Providers Comprised of a Supporting Network of Peers and Shared Services

(71) Applicants: Sekou Page, Santa Monica, CA (US); Michael Park, Santa Monica, CA (US)

(72) Inventors: Sekou Page, Santa Monica, CA (US); Michael Park, Santa Monica, CA (US)

(21) Appl. No.: 16/681,764

(22) Filed: Nov. 12, 2019

Related U.S. Application Data
(63) Continuation-in-part of application No. 15/803,590, filed on Nov. 3, 2017, now abandoned.
(60) Provisional application No. 62/417,209, filed on Nov. 3, 2016.

(51) Int. Cl. G06Q 20/08; G06Q 30/02; G06Q 30/00; G06N 20/00

(52) U.S. Cl. CPC G06Q 20/0855; G06N 20/00; G06Q 30/016; G06Q 30/0283

(57) ABSTRACT

A platform for service providers comprised of a supporting network of peers and shared services is a software based platform that enables service providers to optimize their rates their customers pay for service and covering rates they charge for assisting peer members of the network with their customers while allowing each service provider to maintain ownership of their customers.

### CROSS-REFERENCE TO RELATED APPLICATION

This patent application is a continuation-in-part application of U.S. patent application Ser. No. 15/803,590 entitled “PLATFORM FOR SERVICE PROVIDERS COMPRISED OF A SUPPORTING NETWORK OF PEERS AND SHARED SERVICES” filed Nov. 3, 2017, which claims the benefit of U.S. Provisional Patent Application Ser. No. 62/417,209, entitled “PLATFORM FOR SERVICE PROVIDERS COMPRISED OF A SUPPORTING NETWORK OF PEERS AND SHARED SERVICES,” filed Nov. 3, 2016, which are incorporated in their entirety here by this reference.

### TECHNICAL FIELD

This invention relates to a system and method of determining optimized rates based upon a supporting network of peers and economic modeling.

### BACKGROUND

With traditional models for services, service providers maintain separate and disjoined businesses that service their customers. Each service provider provides a similar set of services to meet customer needs. Existing models for supporting these customers have focused on establishing service providers of all sizes that provide direct support to customers. Under this model, it is only larger service providers that can support large amounts of customers. Each service provider maintains its own unique identity that is presented to the customer receiving service. Service providers will set varied rates due to limited information about what other service providers are actually charging their customers. If a service provider were asked to service customers owned by another service provider as a subcontractor, it would be up to the subcontractor and service provider who owns the customer to determine a rate that works for both parties.

### SUMMARY

The system and method of the present invention allows service providers to optimize their covering rates within a peer supported network as well as direct rates they charge their customers who will receive services from any number of service providers. Shared services and a supporting peer network allow for service providers to optionally leverage a shared identity through a non-exclusive license to a shared brand and service any number customers no matter the size of the individual service provider or to use a white labeled solution to maintain their own identity and brand yet still benefit from the shared services and supporting peer network.

The system and method of the present system that provides service providers with a network of peers who can service their customers under a shared or white labeled brand while allowing account owners to freely set customer rates and members to freely set covering rates.

The system and method of the present system that allows service providers to set unique rates their customers should pay for services and what they would be willing to charge to service another service provider's customer.

The system and method of the present system that determines optimal rates a service provider should define as their rate to service the customers owned by their peers based on static or dynamic parameters.

The system and method of the present system that determines what service providers should charge their customers based on static or dynamic parameters.

The system and method of the present system that notifies service providers when to adjust their covering rates or the rates charged to customers based on static and dynamic parameters.

The system and method of the present system that dynamically adjusts service provider or customer rates based on changes in static or dynamic parameters when a matching parameters profile is found based on previously approved rates.

### BRIEF DESCRIPTION OF DRAWINGS

FIG. 1A shows a partial flow chart for the operation of an application of the system in technology services using a platform with a customer and member application that leverages a backend system to match customer service requests to available members.

FIG. 1B shows a continuation of the flow chart of FIG. 1A at 1B.

FIG. 1C shows a continuation of the flow charts of FIGS. 1A and 1B at 1C.

FIG. 1D shows a continuation of the flow chart in FIG. 1B at 1D.

FIG. 2A shows a partial flow chart for the operation of the system and application in the embodiment of a White Label Agency.

FIG. 2B shows a continuation of the flow chart in 2A at 2B1, 2B2, and 2B3.

FIG. 3A shows a flow chart for determining optimal rates.

FIG. 3B shows a continuation of the flow charts FIGS. 3A and 3C at 3B1.

FIG. 3C shows a continuation of the flow chart FIG. 3B at 3C2.

FIG. 3D shows a continuation of the flow chart FIG. 3A at 3D1 and 3D2.

FIG. 3E shows a continuation of the flow chart FIG. 3B at 3E1.

FIG. 4 shows a flow chart where the system dynamically determining new rates based on changing static or dynamic parameters.

FIG. 5 shows a customer (whose rates were pre-defined by the account owner) making a request for service and defining parameters including type of support and requested estimated time of arrival.

FIG. 6 shows the customer waiting for the system to match the service request with an available member.

FIG. 7 shows the member accepting the request and additional parameters used for the matching like the fact that it is a new customer.

FIG. 8 shows the member setting rates and other parameters (specifically “client promos” which is used to match a new customer that uses a promotion).

FIG. 9 shows a member with the ability to toggle availability on or off.

FIG. 10 shows an implementation of dynamic rates suggesting a member update his rate based on a change of location.

FIG. 11A shows a partial flow chart of an onsite dispatch algorithm.

FIG. 11B shows a continuation of the flow chart of FIG. 11A at 11B1 and 11B2 and is also a continuation of the flow chart of FIG. 11C at 11B2 and 11B3.

FIG. 11C shows a continuation of the flow chart of FIG. 11B at 11C1.

FIG. 11D shows a continuation of the flow chart of FIG. 11B at 11D1 and 11D2.

FIG. 11E shows a continuation of the flow chart of FIG. 11C at 11E1 and is also a continuation of the flow chart of FIG. 11D at 11E1 and 11E2.

FIG. 12 shows a sub process for the “Match” defined in the primary page.

FIG. 13 shows an overview of the system architecture.

FIG. 14 shows an overview of the system architecture with server business logic.

FIG. 15 shows a flow diagram of an embodiment of the call to server logic for retrieval functions of customer optimal rates with machine learning implementation.

FIG. 16 shows a flow diagram of an embodiment of the call to server logic for customer service rate push functions.

FIG. 17 shows a flow diagram for date processing and splitting functions.

FIG. 18 shows a flow diagram of an embodiment of the call to server logic for retrieval functions of member optimal rates with machine learning implementation.

FIG. 19 shows a flow diagram of an embodiment of the call to server logic for member service rate push functions.

### DETAILED DESCRIPTION OF THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of the invention.

### Definitions

The system (also referred to as the network)—Platform for Service Providers Comprised of Supporting Network of Peers and Shared Services

Rate—the amount charged to a customer for services.

Covering Rate—the amount a member of the system is willing to work for when servicing other member's customers.

Favorite—the preferred member of the system for servicing a particular customer which allows the member to receive requests from the customer with priority.

Member—a member of the network of service providers

Account Owner (AKA Member Owner)—The owner of a particular customer who defines rates for that customer.

Agency—the entity providing the system for service providers and the network of service providers.

White Label Agency—Service provider that has white labeled Agency's Platform for Service Providers Comprised of Supporting Network of Peers and Shared Services

Peer—mutual service providers.

Customer—entity receiving service from service providers or members of the network.

Service provider—entity that performs services for customers.

Shared services—services available to service providers directly and/or or to their customers that are provided by the Agency.

Parameters profile—collection of parameters for a specific scenario.

The system of the present invention utilizes a software based platform run by an agency that enables customers in need of a service to receive quick, efficient, and cost-effective service from a network of service providers associated with the agency. The service received may be from the customer's regular service provider, or a peer service provider. The regular service provider is the service provider who originally acquired the customer. The peer service provider is a qualified service provider who is part of the network of service providers associated with the agency and renders services to a customer who was not originally acquired by that service provider. Therefore, the arbitrary labeling of a service provider as a regular service provider or a peer service provider is used in this application simply for ease and clarity to identify whether the service provider is providing services to his or her own customers or to another service provider's customers.

The system allows service providers to optimize the direct rates customers pay for services rendered by their regular service provider, and the covering rates customers pay for services rendered by peer service providers, while allowing each service provider to maintain ownership of their customers.

### Members

Service providers, whether they are individuals or organizations, are able to join the agency as members for access to the system. Once joining the agency as a member, the member creates a profile. The member has the option to associate with another organization that is receiving services from the agency as a white label agency or may be a direct member of the agency. The member will then populate profile data including, but not limited to, direct rates, covering rates, skills, expertise, licenses, languages spoken, location, and other data that will be used for matching with a customer request.

Members may also bring their own customers into the agency. Members who bring their own customers into the agency are referred to as account owners. In a sense, the member who is an account owner “owns” the customer, or more technically, the customer account, that the account owner brought into the agency. Account owners may define the rates for their customers.

### Ownership Model

In the preferred embodiment, all customers may be owned by members and the Agency does not own any customers directly. Nonetheless, it is possible for the Agency to own customers with this model. If the Agency were to own customer accounts, it would need to set rates and maintain the customer relationship.

### Member Availability

Since service providers have different availabilities, the system allows customers to choose from any available member. The member needs to be able to indicate when they are available or not in order to ensure that requests are not sent to them when not available.

This makes it important for account owners of customers to be able to tell how likely their customer is to receive services based on the percentage of the members that would match for requests made by their customer.

Requests are typically only sent to available members though it is possible to send offline requests to the members (e.g. as an email, phone call, instant message, or SMS) or to the Agency as well based on the same criteria that was used in the online request. The agency can also act as a backup destination for requests when no members are available.

### Agency Request

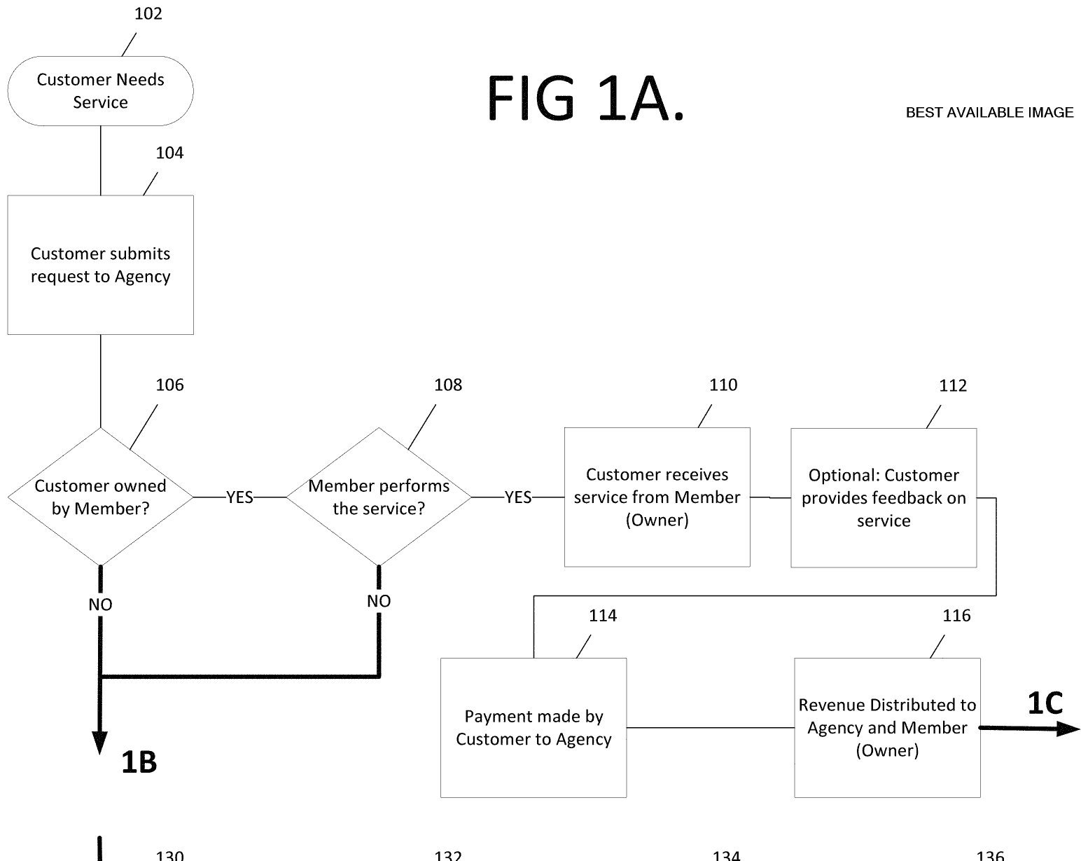

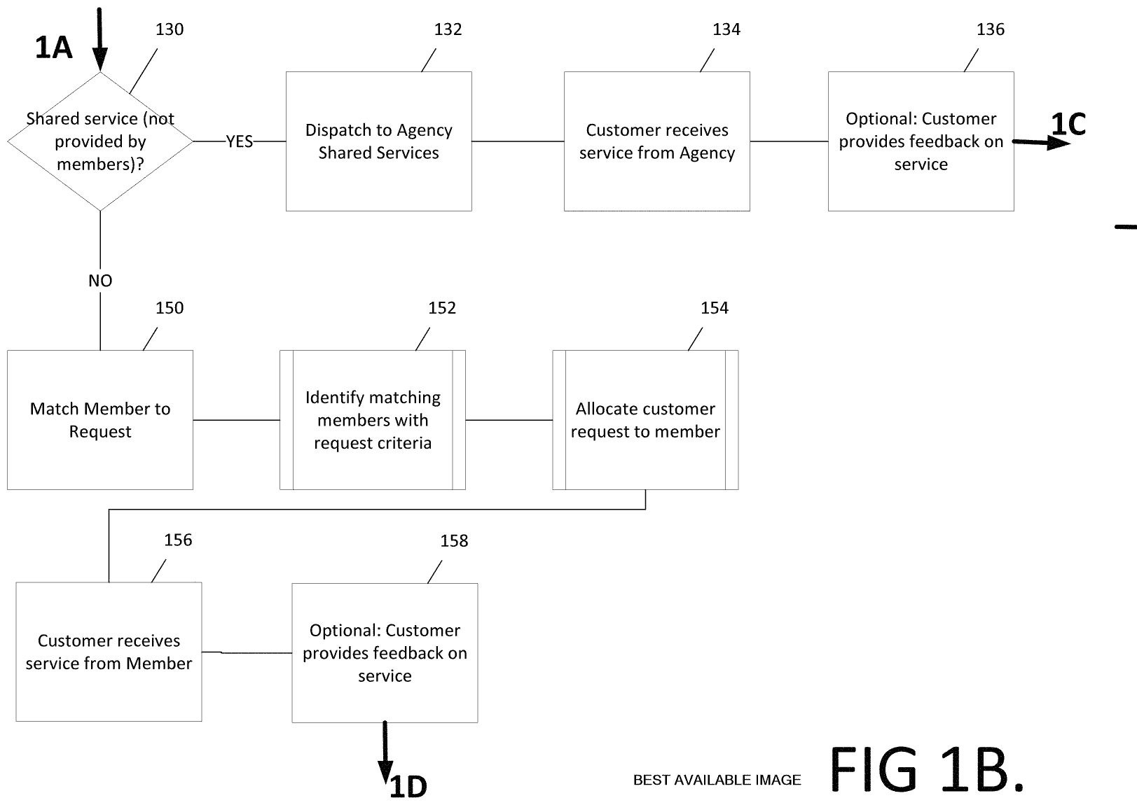

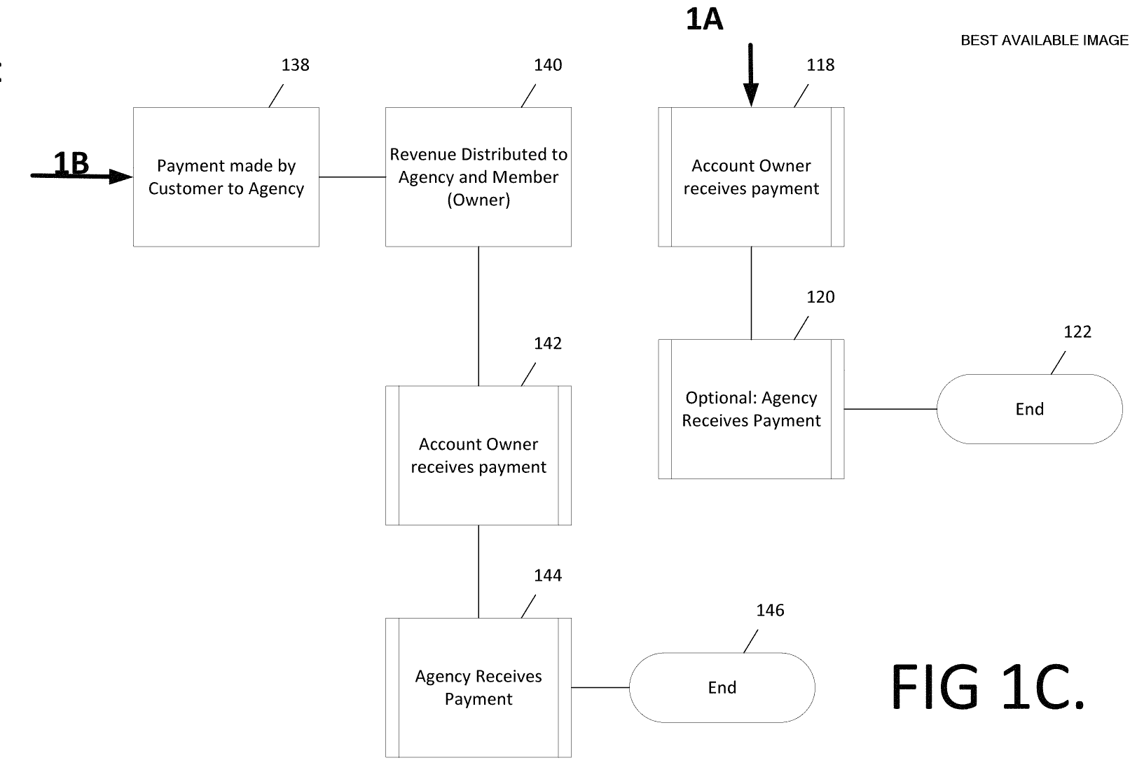

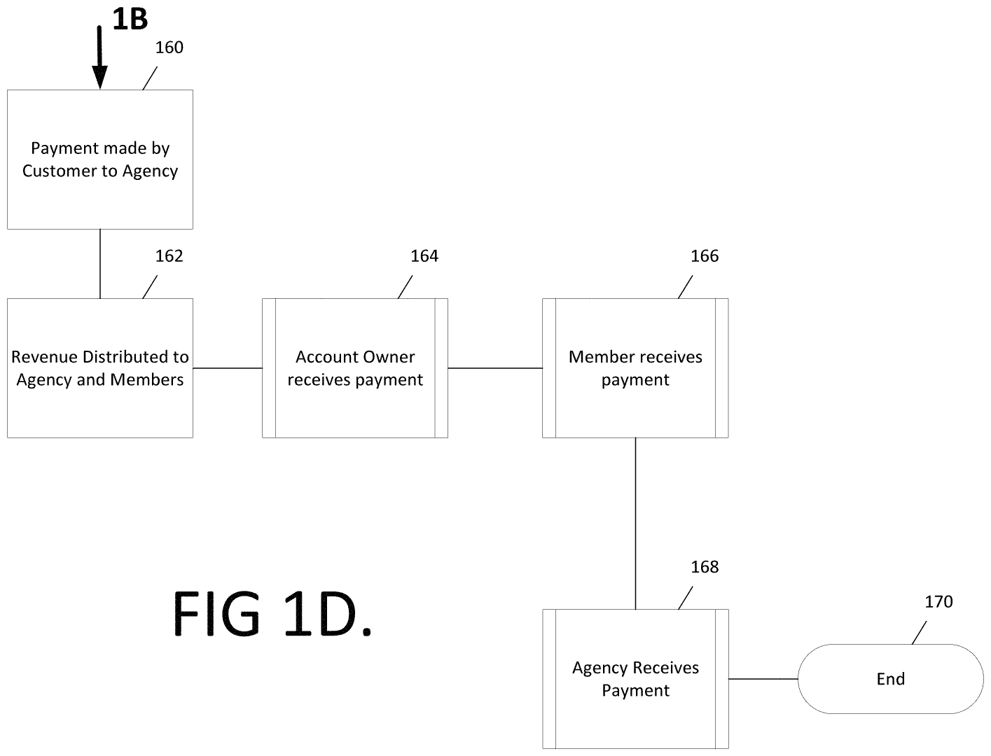

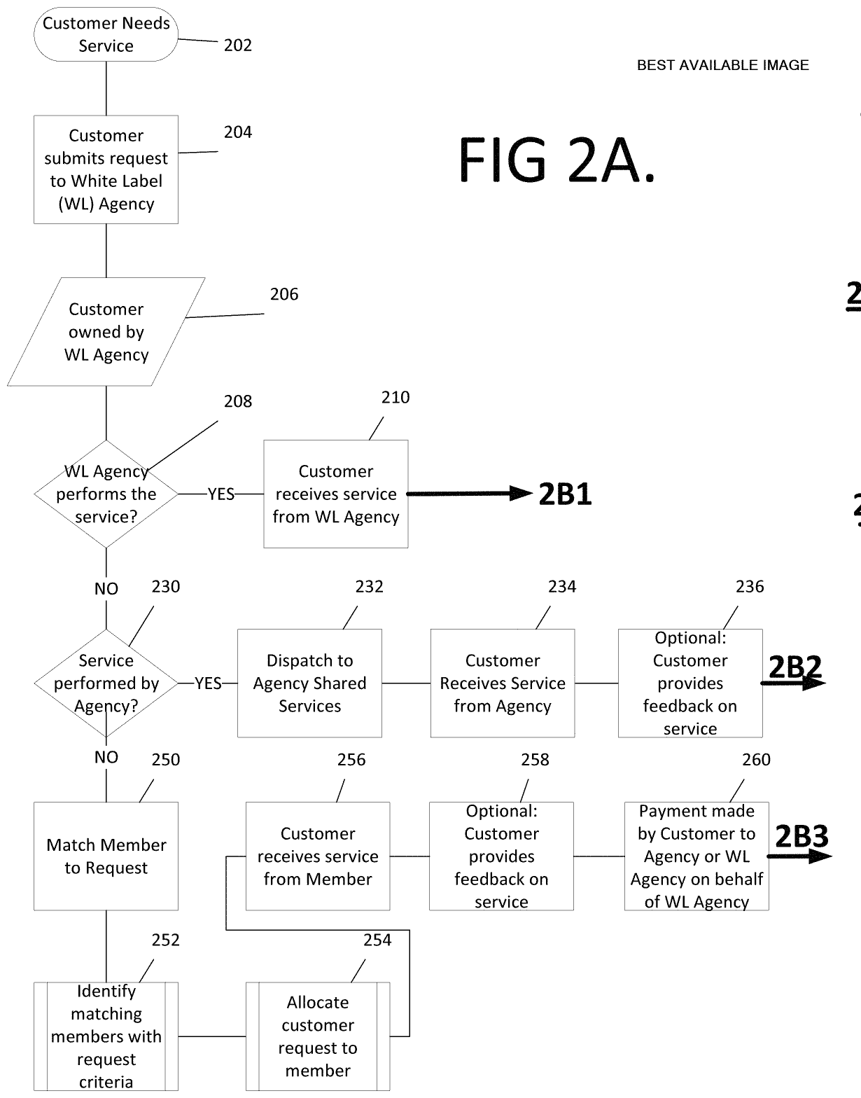

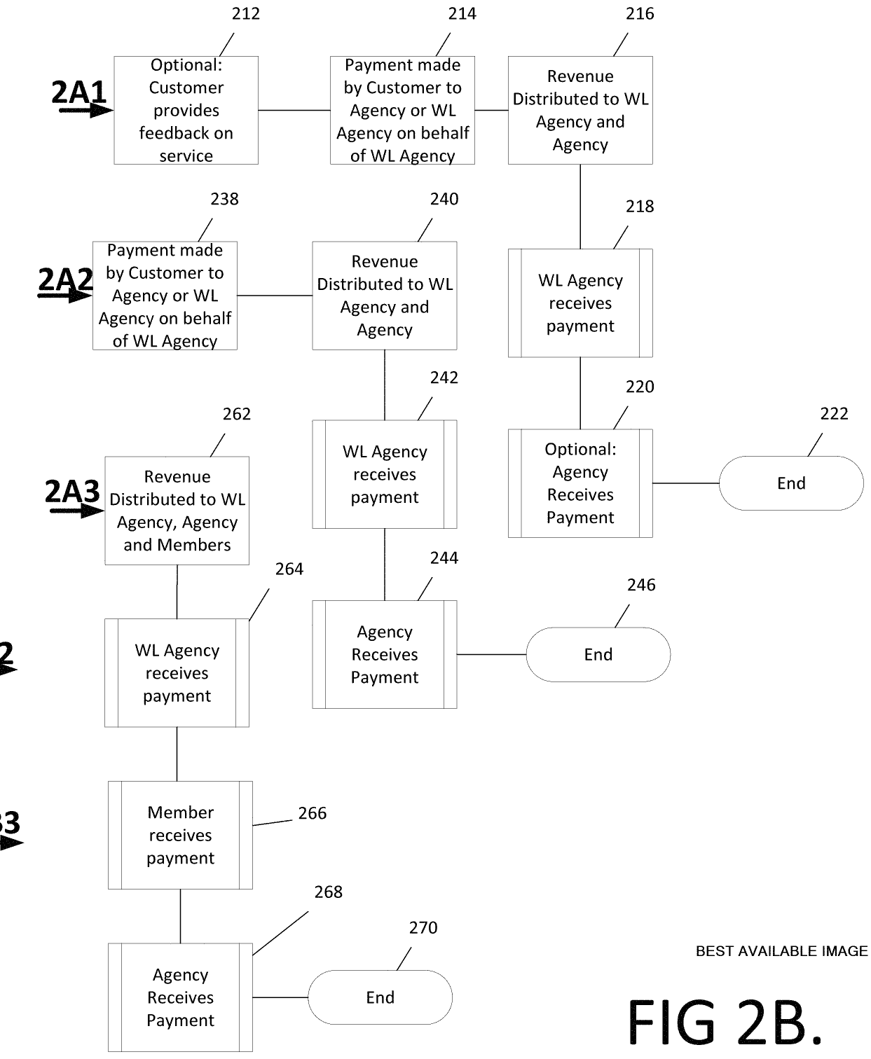

With reference to FIG. 1, once in the system, a customer in need of service 102 may request services 104 from any member in the system. There is a model for when the agency receives requests directly (FIG. 1) and for a White Label Agency (FIG. 2).

When the agency receives requests directly from a customer, the customer submits requests directly to the system 104, for example by logging into an established website or by launching an app on a mobile device, such as a smartphone or a tablet, and entering the pertinent information. When the customer's information is received by the system, the system determines whether the customer is owned by a member 106. This first decision “Customer owned by Member?” may be from the perspective of the member being evaluated by the system, though as mentioned previously, all customers are owned by members in the optimal model. For the service to be performed, if the customer is owned by the member in question (i.e. the account owner), the customer has the option to receive services from the account owner 108. If the account owner agrees, then the account owner renders his services to his customer 110. At the customer's option, the customer may provide feedback 112, such as comments regarding the quality of service, ratings, responsiveness, and the like. The customer can make payment 114 to the Agency. The payment may be distributed 116 so that the account owner receives compensation 118 and optionally, the Agency may receive a portion of the payment 120. This concludes the transaction 122.

If for the service to be performed, the customer is not owned by the member in question or if the member who is also the account owner chooses not to perform the service and allow another member to do so, the main decision is whether or not a shared service will be used 130. In the preferred embodiment, if the agency has a service provider available, the agency decides whether to accept or decline to render its shared services.

The agency provides shared services which can service all member owned customers as well as provide services directly to members as needed. If shared services will be used 132, the request is serviced by the agency shared services 134 and the customer receives services directly from the Agency. The customer may have an opportunity to provide feedback on that service 136, which the account owner can review. Payment is made to the agency 138 and revenue is distributed between the agency and the account owner 140. So, the account owner is paid 142 for having brought the customer into the agency, and the agency is paid 144 for its services. This concludes the transaction 146.

Generally, if a customer requests service and the customer's account owner is not available, the agency will provide its shared services. In the preferred embodiment, the agency will almost always provided services to a customer when the customer's account owner is not available, unless the agency's service provider from its shared services is also not available, in which case the system will find the best match with another member 150. In the case when the agency shared services will not be used, the request is distributed to other members of system. This is done by matching members based on rate and other properties defined in their profile and may leverage additional parameters with the customer request 152. Other factors such as distance, highest margin, highest ratings, and more can be used to determine who is matched. Once a match is made, the customer request is assigned to the member 154. Since this member is not the customer's owner, for purposes of nomenclature, the peer member will be referred to as a peer member. The customer receives services 156 from the member and optionally provides feedback 158. Payment is made to the agency 160 and revenue is distributed among the agency and the involved members 162. So, the account owner is paid 164, the peer member performing the services is paid 166, and the agency is paid 168. This concludes the transaction 170.

### White Label Agency Request

In some instances, a member may wish to provide the services of the present invention but under a different name than the agency. In such a situation, the service may be referred to as a white label agency. The flow diagram of the white label agency process is shown in FIG. 2. Essentially, the process is similar to the flow in FIG. 1 except from a customer perspective the request is being handled by the white label agency. In all cases, the customer is owned by the White Label Agency with no other members owning clients. Another difference is the white label agency may wish to perform shared services that are usually provided by the agency. In addition, payment can also be collected by the White Label Agency or optionally by the Agency on its behalf as a billing service. All other aspects of the flow are similar to the standard Agency flow including matching members to requests serviced by the system, feedback on service, and allocation of requests.

The White Label Agency is treated the same way any other account owner would be treated from the logical perspective of the model. However, White Label Agencies choose to use their own brand and receive a version of the system with their branding. This means the White Label Agency may have higher fees including those not directly included in the model for the right to white label. If the White Label Agency performs the service, revenue is split between the White Label Agency and optionally the Agency.

For the White Label Agency model, the concept of Shared Services is slightly different. The White Label Agency may have the capacity to perform the services that were previously done by the Agency as shared services. When the White Label Agency services are not used and services are instead needed from the Agency, the customer receives those services directly from the Agency or from the members of the system. In the case when the customer receives services directly from the Agency, the Agency is compensated for the work performed and the White Label Agency is compensated as the account owner. When the members of the system perform the service, the member is compensated at the rate requested and the White Label Agency and Agency divide the remaining balance.

By way of example only, with reference to FIG. 2, when a customer needs service 202, the customer submits a request 204 to the White Label Agency. The system determines whether the customer is owned by the White Label Agency 206. The White Label Agency determines whether it will perform the services 208. If the White Label Agency performs the service, then a service provider renders the requested service 210. The system may offer the customer with the opportunity to provide feedback on the service received 212. The customer pays for services rendered 214. The customer makes payment 214 to the White Label Agency directly, or it may pay the Agency on behalf of the White Label Agency. The payment is then distributed 216 between the white label agency in the agency. The white label agency receives its share 218 for the services rendered. The agency may also receive its share 220 for providing or making the system available for the white label agency. This concludes the transaction 222.

If the White Label Agency does not perform the service, either by choice or because no service provider was available, the agency is offered the opportunity to renders services 230. If the agency chooses to provide the service, then the agency dispatches its shared services 232. The customer receives the service from the agency 234. Optionally, the customer may provide feedback on service 236. Customer then pays 238 the agency or the white label agency since it was the first point of contact. The payment may be distributed between the white label agency and the agency 240. Therefore the white label agency receives its payment 242. And the agency receives its payment 244 for the services rendered. This concludes the transaction 246.

If the agency does not perform the service, either by choice or because no service provider was available, the request is processed to find the best match from the system's database 250. Once a match is identified 252, the customer's request is submitted to the member matching the request 254. The customer then receives services from the member 256. Optionally, the customer may provide feedback on the services received 258. The customer makes payment to the agency or the white label agency 260. The payment is then distributed between the white label agency, the agency, and/or the member 262. Therefore, the white label agency may receive payment 264 the member may receive payment 266, and the agency may receive payment 268. This concludes the transaction 270.

### Optimal Rates

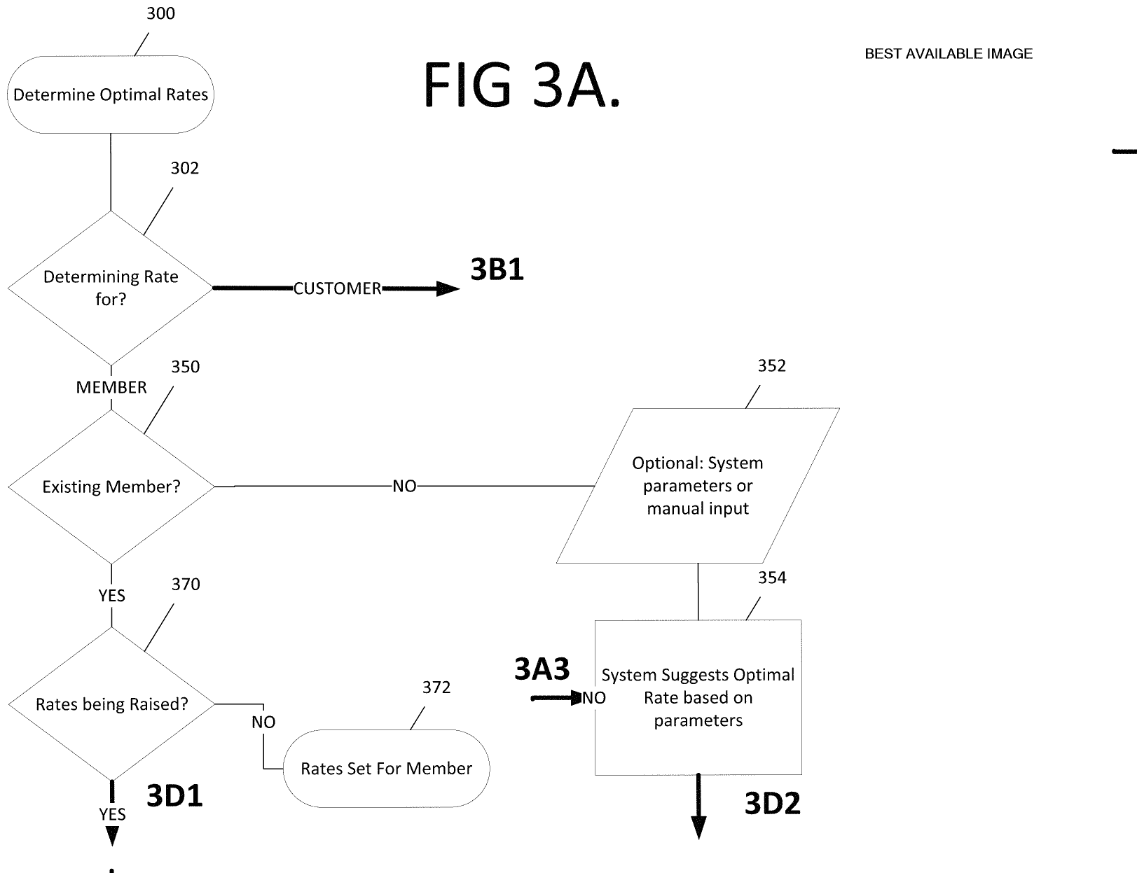

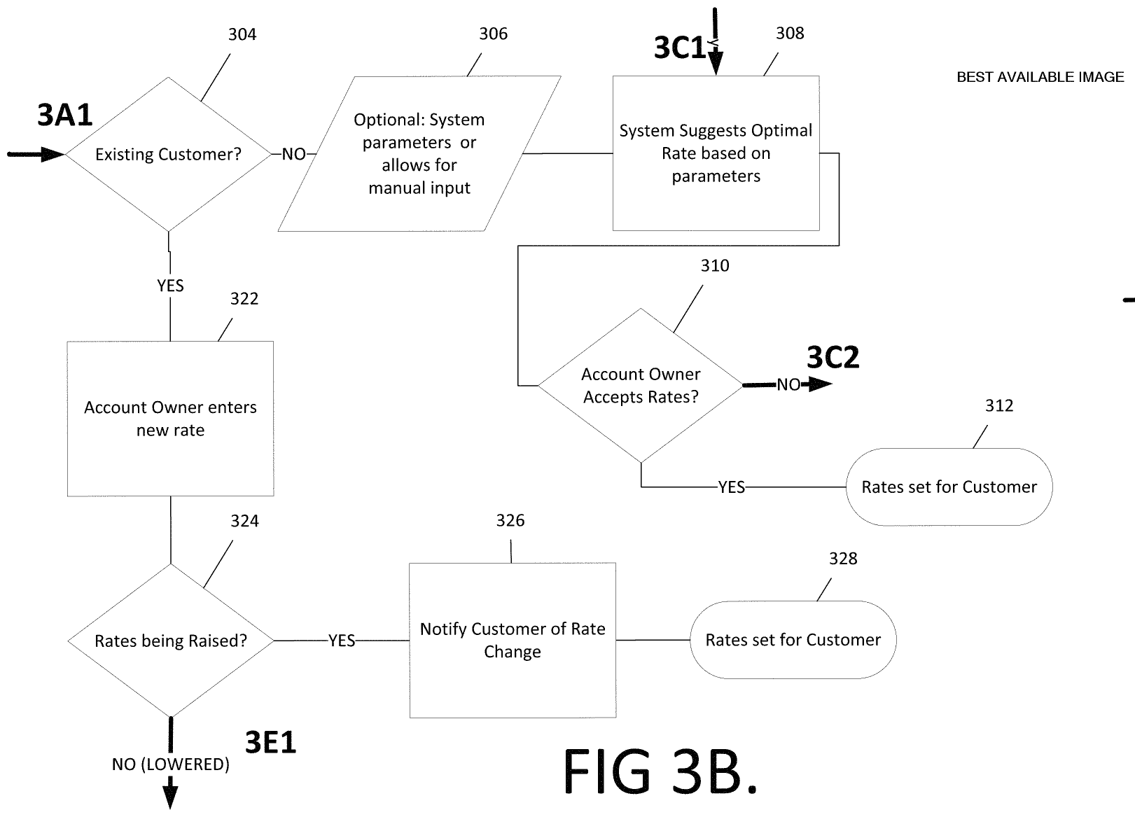

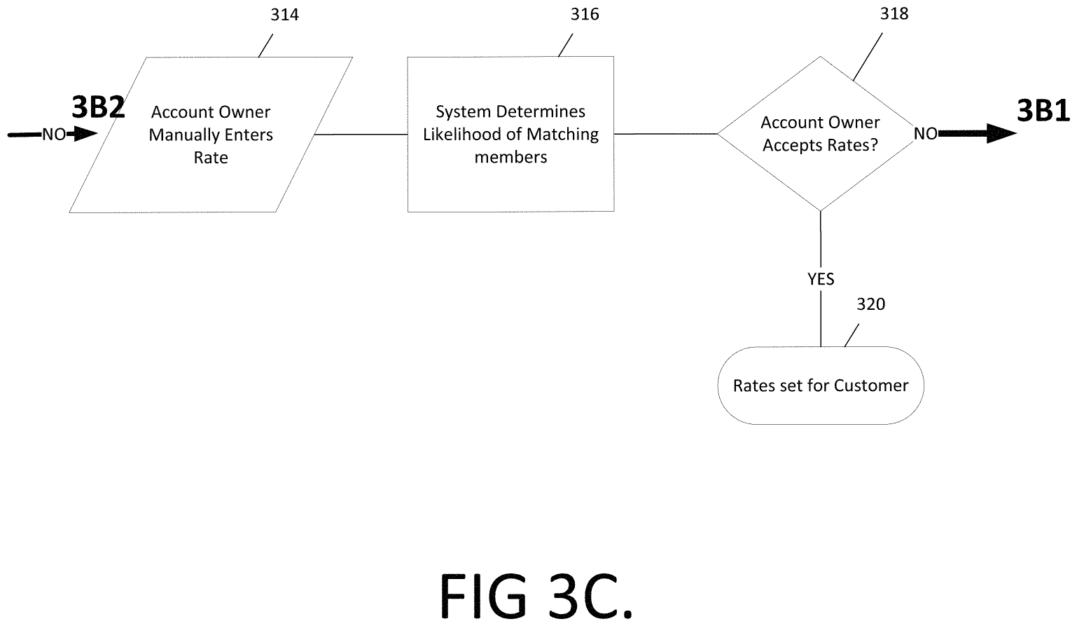

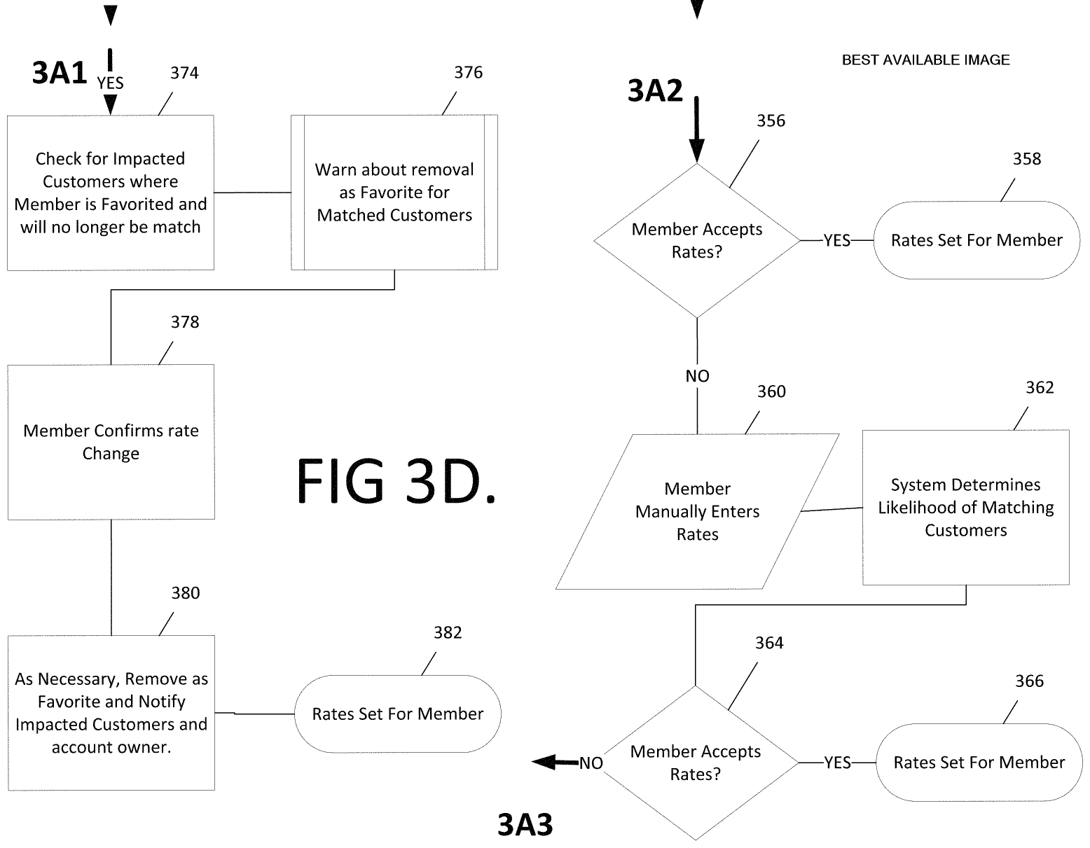

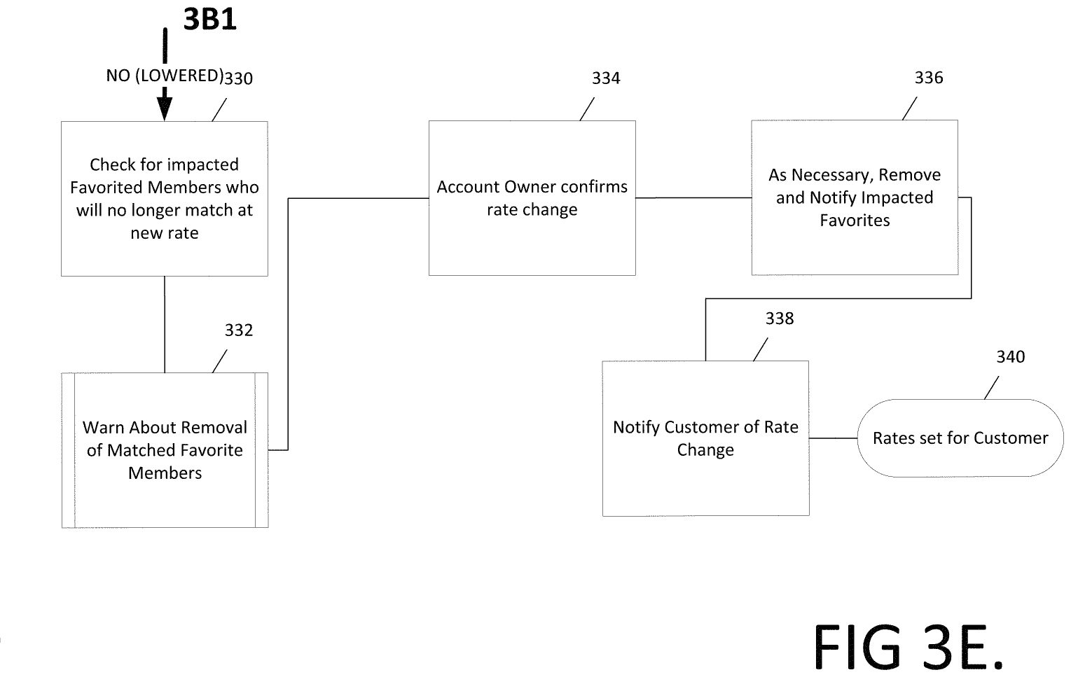

Since the system creates a single system for members and customers, it becomes necessary to optimize these rates for the system to be successful in servicing its primary function of matching customers with members and enabling service providers to extend beyond their standard capabilities. FIG. 3 is a flow diagram for determining optimal rates 300. Optimal rates described in FIG. 3 determine the rate a member of the system should charge customers and the covering rates members should define in their profiles when servicing customers owned by other members. Therefore, the first step is to determine who the rate is for 302, a user signing up as a customer, or a user signing up as a member.

### Customer Rates

When determining the rate for a customer, the system must first determine whether the customer is in existing or new customer 304. If it is a new customer, the system may use dynamic and static parameters to assist in creation of optimized rates (for example, location, current weather, interest rates, covering rates nearby, availability of other service providers, etc.). Manual input 306 may be allowed for these parameters (for example entering a specific zip code or indicating non-profit customer). The system then suggests an optimal rate for the customer based on matching members 308 (for example ensuring there is a statistically higher chance the customer will receive services from a vendor). The account owner has a choice of accepting the rate 310. If the account owner accepts the rate, then the rate is set for the customer 312. If the account owner rejects the rate, then the account owner may override this rate and manually enter his or her own rate 314. With the new rate entered, the system determines a likelihood of matching members 316 and the account owner is advised of the impact to the likelihood of matching members for coverage (either positive or negative). The account owner then has the option of accepting this rate 318. If the account owner rejects this new rate, then the system suggests an optimal rate again 308 in the process repeats. When the account owner accepts the new rate 318, then the new rate is set for the customer 320.

If the customer is an existing customer, then the account owner has the option of entering a new rate 322. The account owner may either raise the rate or lower the rate 324. If the rate is being raised, then the customer is notified of the rate change 326 and the rate is set for the customer 328.

If the rate is being lowered for an existing customer (should be done by the account owner), this requires that a check be done against any favorites 330 (preferred members the customer or account owner may have defined) the customer may have. This is not required when the rate is raised. This is because when the rate is lowered, the covering rates defined by those members may no longer be considered a match. In theory other parameters could also be modified and used to determine any favorites that should be removed from a customer. Notifications should be sent out as appropriate to the customer and any impacted favorites in the event of a rate change. If any customers are impacted, then the account owner should be warned about the removal of matched favorite members 332. If after the warning the account owner wishes to proceed, then the account owner can confirm the rate change 334. Any impacted favorites can be notified and removed as necessary 336. The customers may be notified of the rate change 338, and the new rates are set for the customer 340.

### Member Rates

If the optimal rate being determined is for a user signing up as a member, the system must first determine whether the member is an existing member 350. When a member first joins the system, he/she receives a suggested optimal covering rate to define based on dynamic and static parameters 352 (for example, location, current weather, customer rates, skills defined, availability of other providers, etc.) Manual input may be allowed for parameters (for example entering a specific zip code or indicating specific times of day for availability). The system then suggests an optimal covering rate 354 for the member to charge for services for clients owned by other members. The member has the option of accepting this rate 356. If the member accepts the rate, then the rate is set for that member 358. If the member rejects the rate, the member may override this rate and manually enter a new rate 360. The system then advises the member of the impact on the likelihood of matching customers in the system 362 (either positive or negative). After being so advised, the member has the option of accepting the new rate 364. If the member accepts the new rate, then the new rate is set for the member 366. If after being advised of the impact of the likelihood of matching customers, the member desires to reject the new rate, the system will again suggests an optimal rate based on the parameters 354 and the process repeats again.

If the member is an existing member, then the system must determine if the rate is being raised for the existing member 370. If the rate is not being raised, then the rate is set for the existing member 372. If the rate is being raised, then a check may be performed against any existing customers where the member is favorited (preference that allows a member to receive preference on any requests made by the customer) to determine if a customer will be impacted by this rate change 374. This is because when the covering rate is raised, the member may no longer be a match for the rate of his/her customers. In theory other parameters could also be modified to impact suitability to service another member's customers such as skills removed, available hours changed, etc. Notifications may be sent to the impacted customer and account owner 376 in the event of an impacting covering rate change. This gives the member the opportunity to confirm the rate change 378. If the member accepts the new rate, then the members status relative to a customer may be changed (e.g. the member may no longer be a favorite of the customer) and the impacted customer and account owner may be notified 380. The new rate is unset for the member 382.

### Dynamic Rates

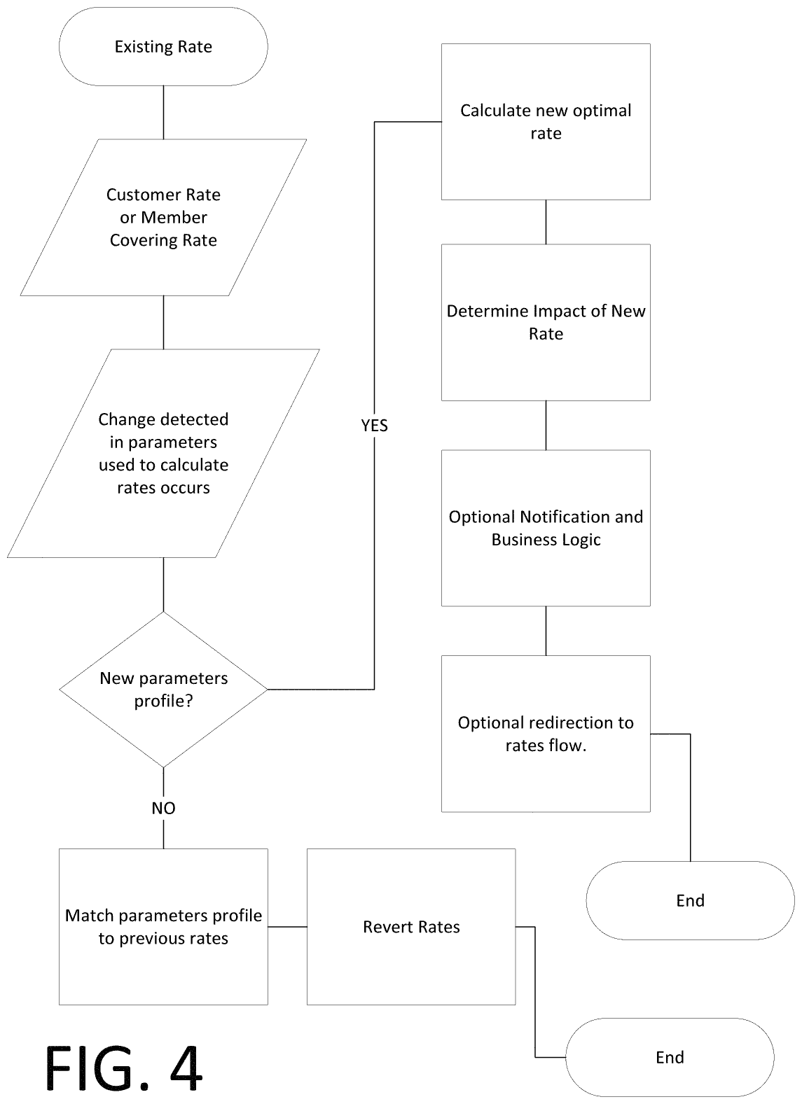

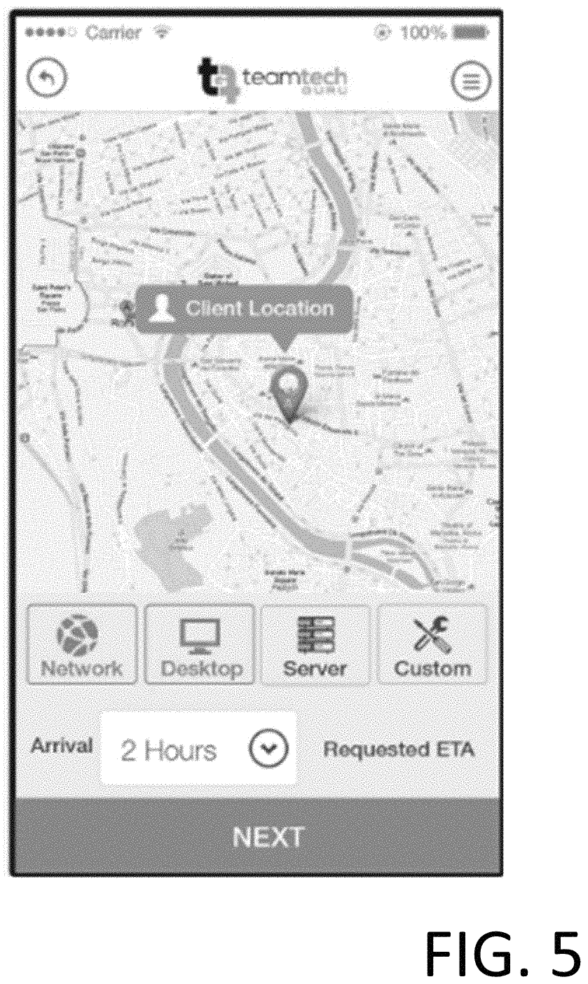

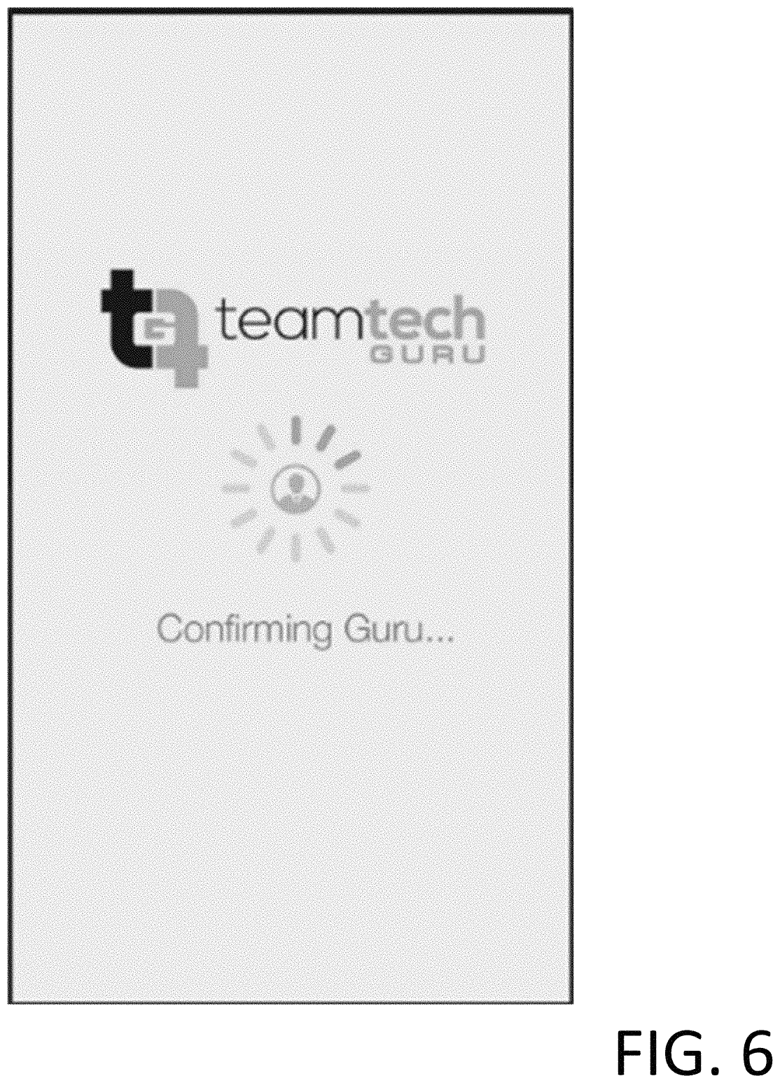

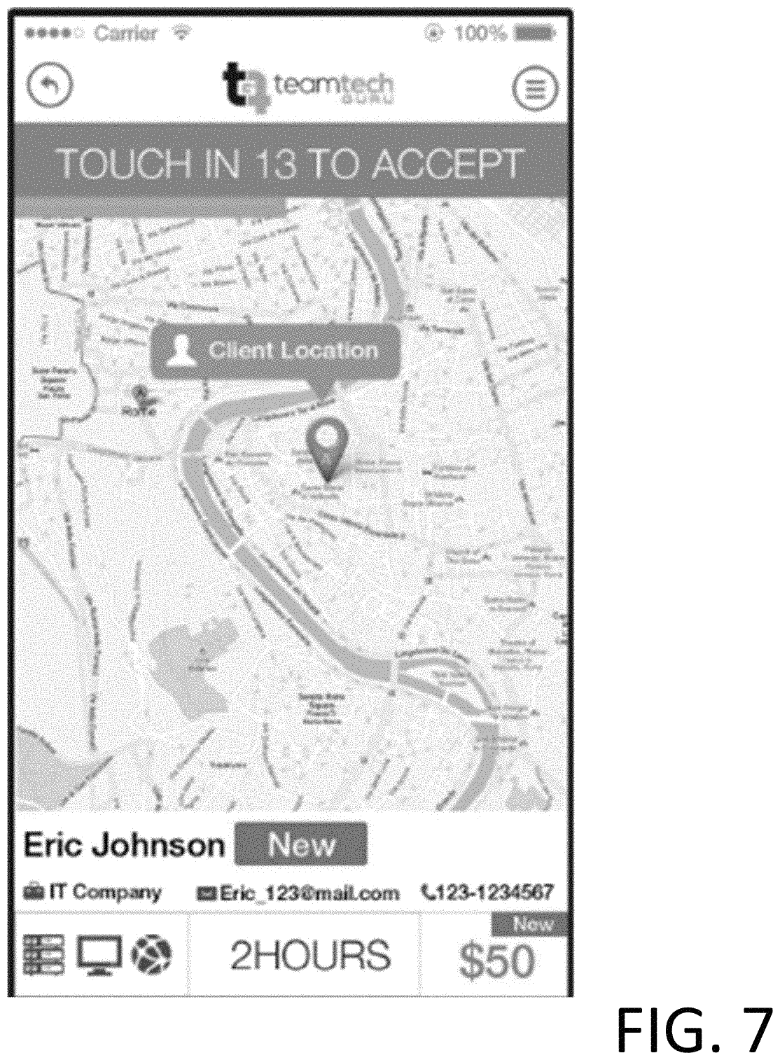

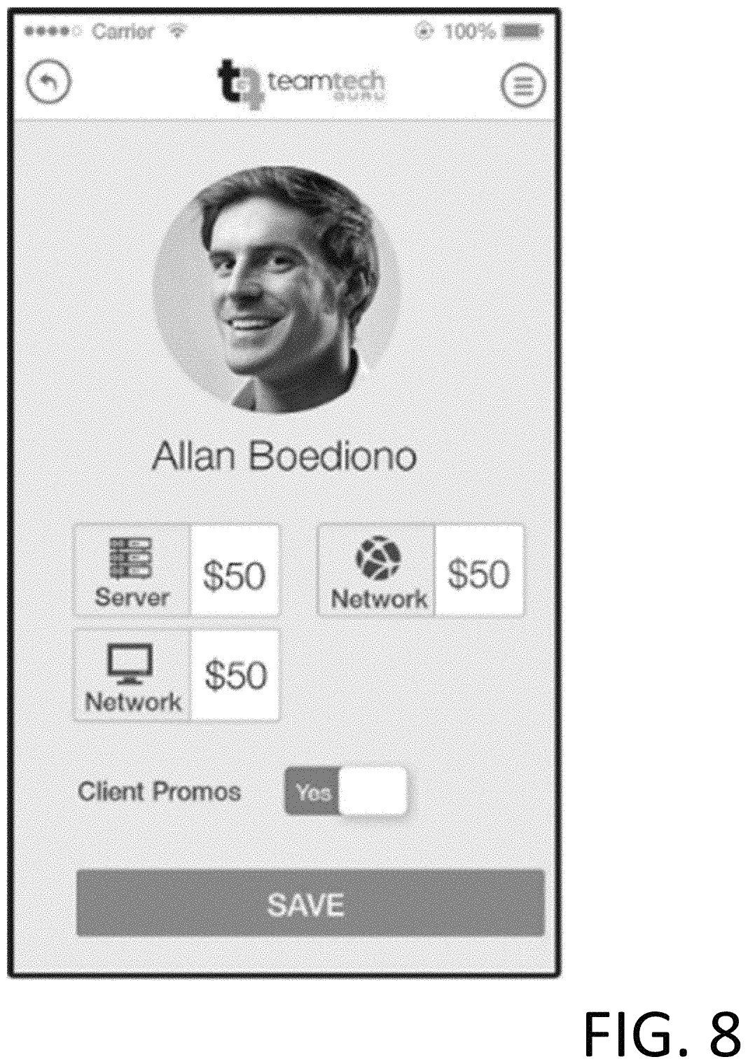

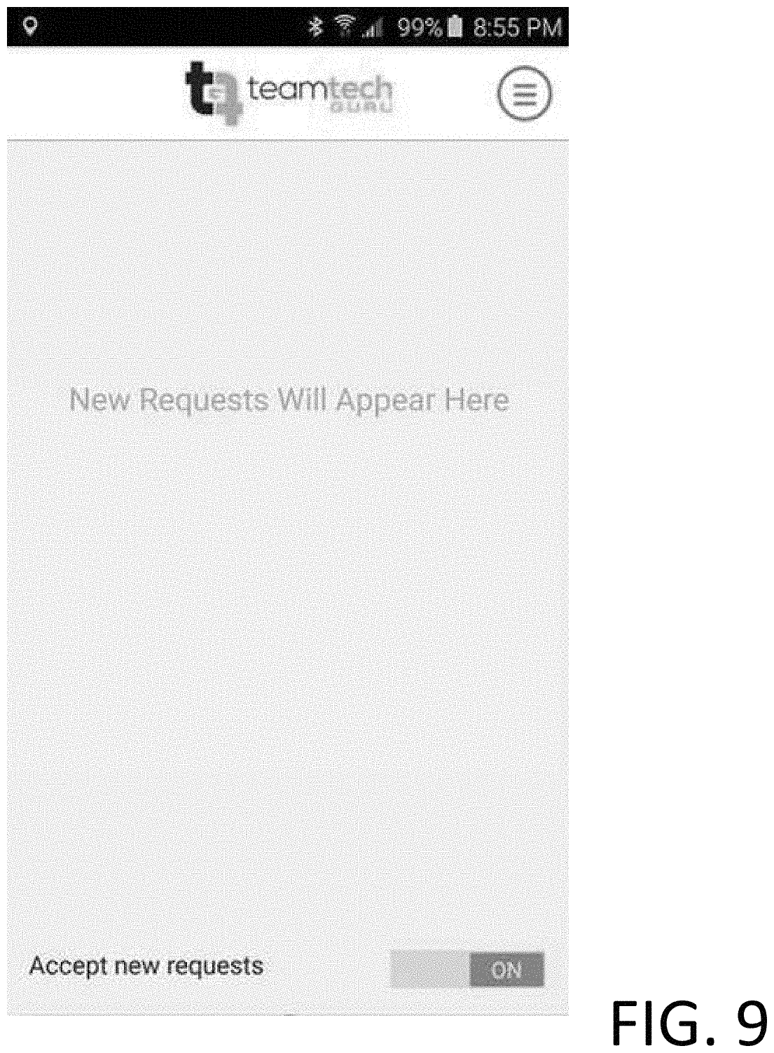

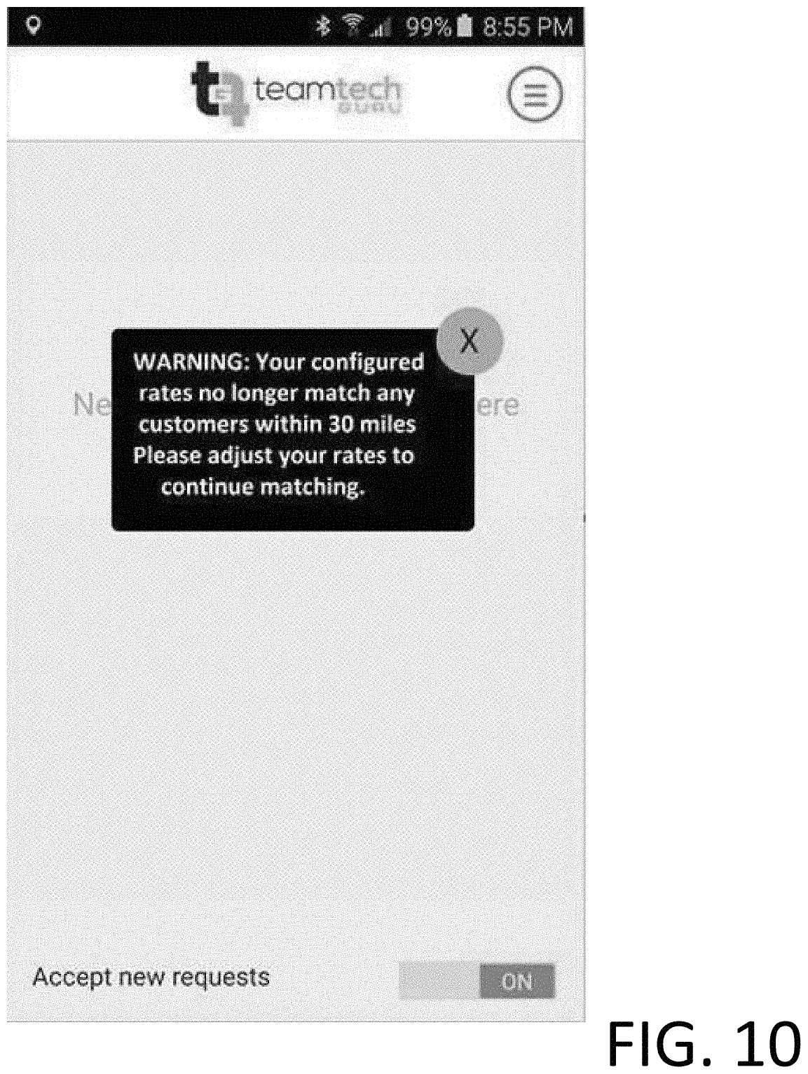

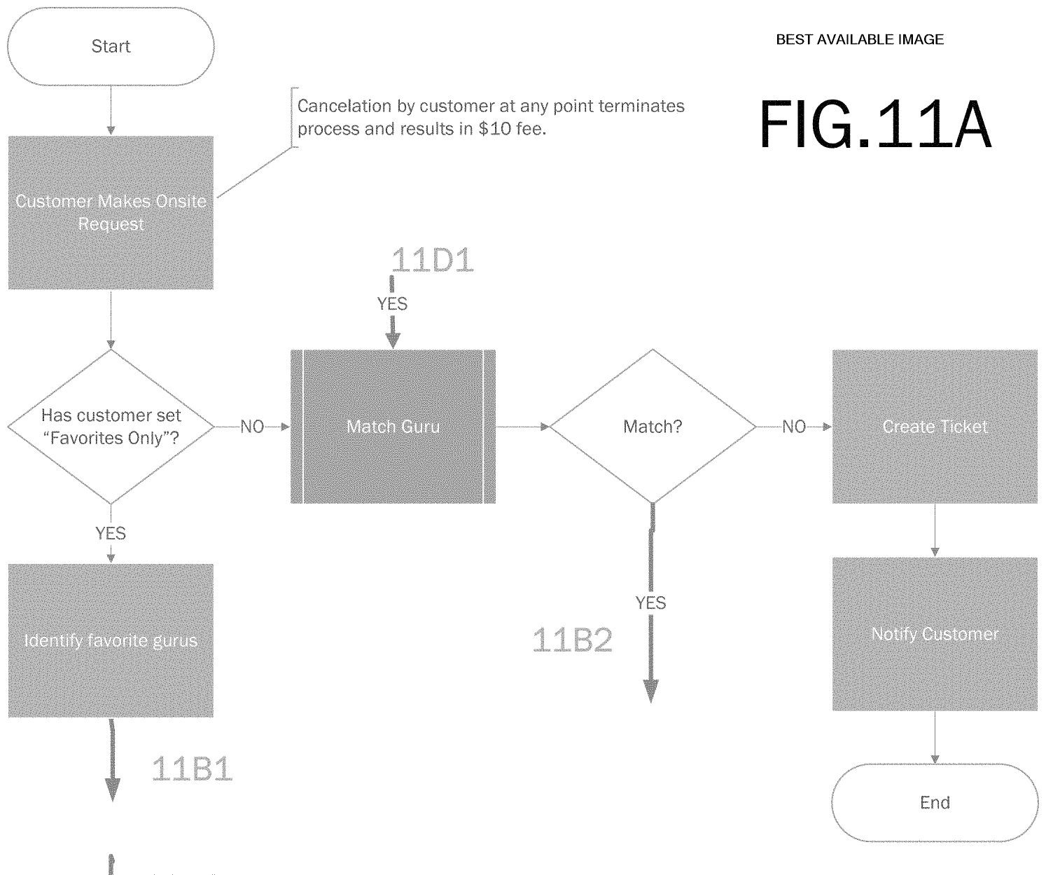

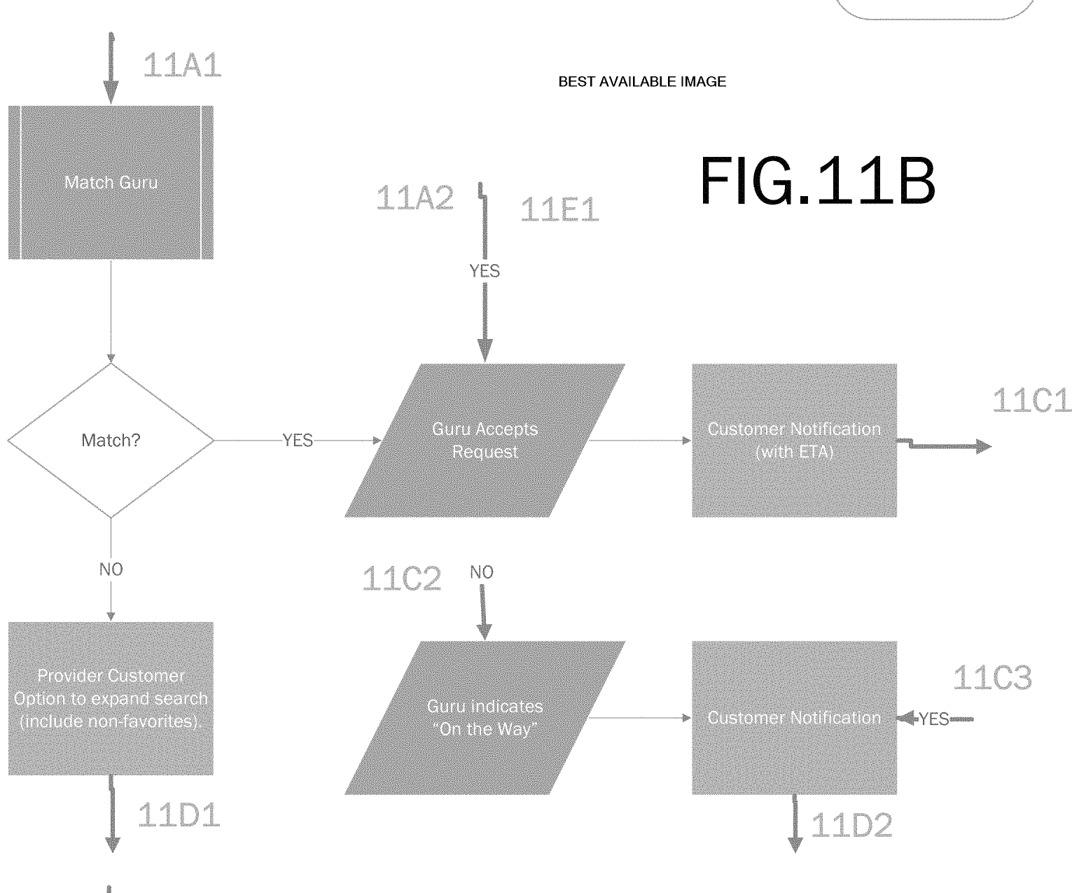

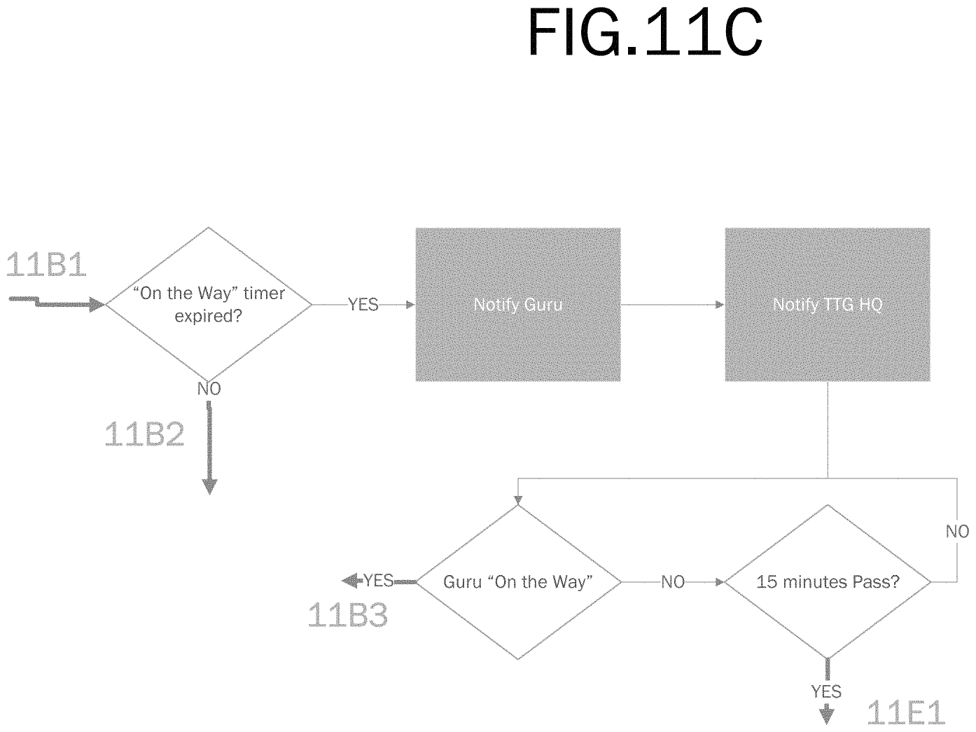

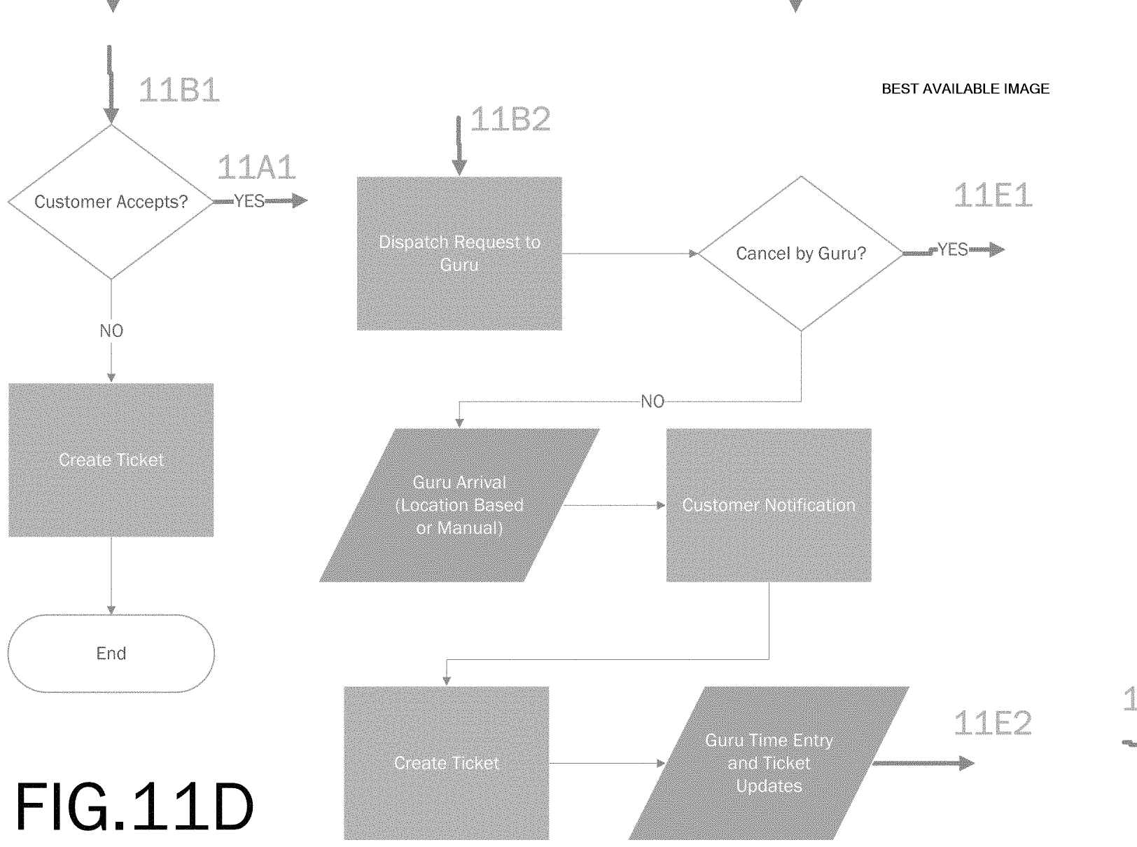

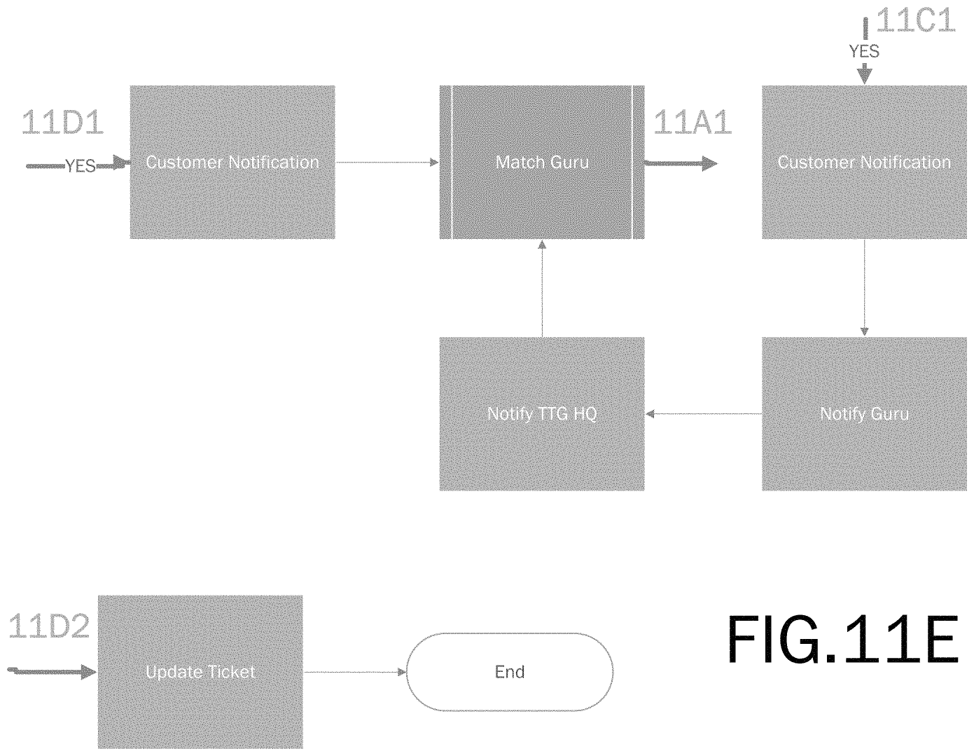

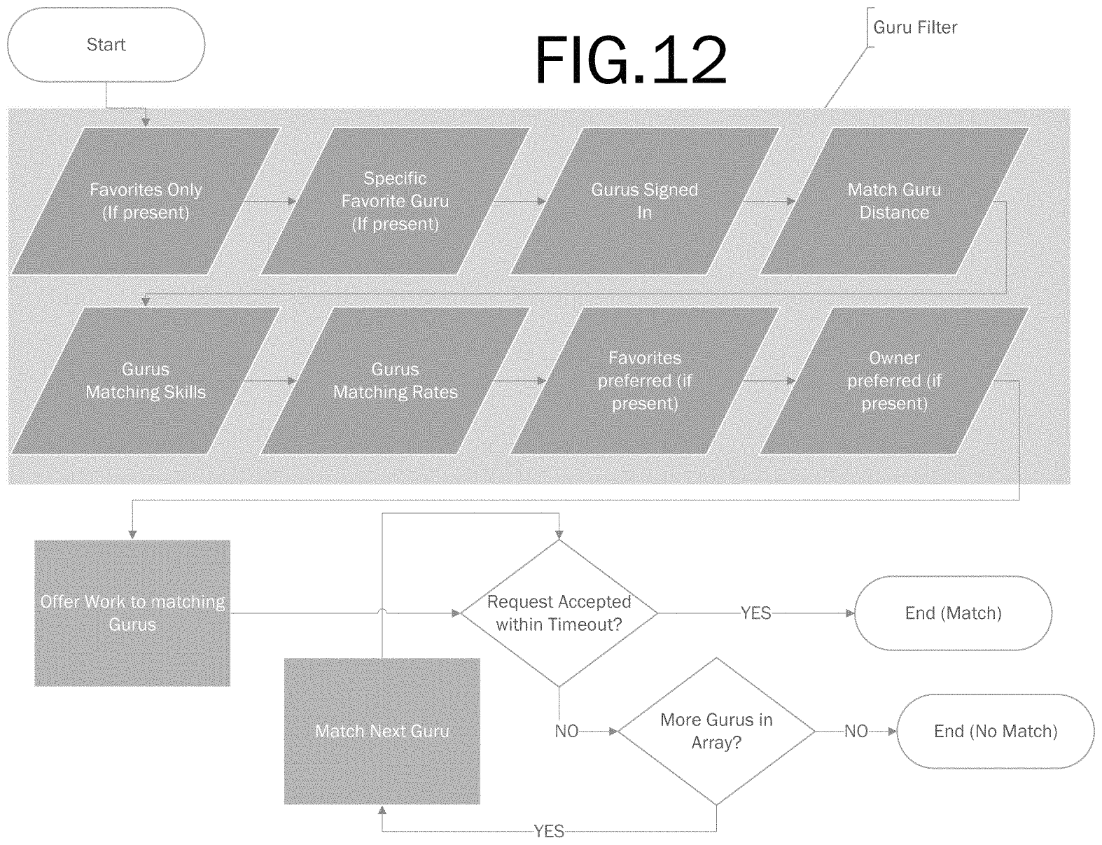

FIG. 4 describes the flow for taking an existing rate 400 and dynamically determining new rates based on changing static or dynamic parameters. This flow applies to both customer rates and covering rates for members 402. The system monitors parameters for determining rates. When a parameter that impacts rates changes (such as location, weather, interest rates, other rates in the system, etc.) the system detects the change 404 and calculates the impact of the change in parameters on the existing rates defined in the system. A parameters profile may be established that associates a particular rate with a particular set of parameters for a specific scenario. Therefore, when a parameter changes, the system determines whether a parameters profile exists for the changed parameter or whether a new parameters profile should be established 406.

If a parameters profile exists for the changed parameter, then the system finds the match for that parameters profile 408. The rate for that parameters profile is identified and the new rate is reverted to the identified rate 410. In other words, if the parameters profile is known this allows the system to either suggest or dynamically adjust covering rates on behalf of the members when they travel to a different geography, for example. This concludes the process 412.

If the change in the parameter results in a parameters profile that does not exist, then a new parameters profile is established. The system then calculates a new optimal rate 420. The impact of the new optimal rate is determined 422. The impact can be considered positive or negative. Therefore, the account owner and/or its customers may be notified of this change 424. For example, a change in location may result in a covering rate defined being too high to match any customers. This negative change could be communicated to the member to allow them to change their rate when in a different geography. In this example since lowering one's rate may remove them as a favorite for existing customers it is recommended that any rates suggested by the system be tied to specific sets of parameters to allow for rates to revert when a previous set of parameters are detected.

For a customer rate, an example could be alerting an account owner about changing a customer rate due to competitive rates in the region or member covering rates. In addition, this process can redirect a member or account owner (in the case of a customer rate) to the rates flows 426 described in FIG. 3 to determine the optimal rate and to approve the rate change. This concludes the process 428.

In an embodiment of this invention the rates may be dynamically updated based upon machine learning or economic neural networks that detect patterns of price behavior and optimize rates in the system.

FIG. 1 is an application of the system in technology services using a mobile platform with a customer and member application that leverages a backend system to match customer service requests to available members.

### Account Manager

The Account Manager may be a member who owns the relationship with a customer and is focused on customer acquisition, but does not wish to directly service them. The account manager may acquire as many customers as possible and have all other members of the network perform services. Technical Workers may be used for all onsite requests. The account manager may typically serve in an “account manager” capacity by meeting semi regularly with the customer to see how they are doing. More technical account managers may also act as an Architect by recommending new strategies and projects for the upcoming period. The account manager may be focused primarily on building their business.

### Technical Owner

The Technical Owner may be a member who owns the relationship with a particular customer. The technical owner may have brought the customer into the Network and may be working with the customer directly. The technical owner may be backed up as needed by technical workers, typically when he/she doesn't have the capacity to take on the work, needs to go on vacation, or may otherwise be unavailable. Since the technical owner may be focused on working with customers directly, he/she may only handle a limited set of customers, may be overloaded at times, and may not focus on expansion. The technical owner has built and may be maintaining a business but not necessarily expanding.

### Technical Worker

The technical worker may be a member who is either employed full time elsewhere and looking for extra work or may be a full time consultant that does not have any customers. The technical worker may not have an interest in account ownership, customer acquisition, or customer management and may instead see the system as a means to make extra income. The technical worker may indicate availability for on demand coverage and choose when and where he/she works. The technical worker may also provide additional expertise that is part of the system's network since each member may bring in a diverse set of skills. The technical worker may have one or two clients and be the technical owner for those, but may not really be building a business.

### Customer

The customer may refer to the direct end customer that may be owned by a technical owner or account manager and supported by the system's network. The system may represent everything the customer needs to support the IT needs of their organization. The customer can also be considered a non-technical user of the system's services.

### System Architecture

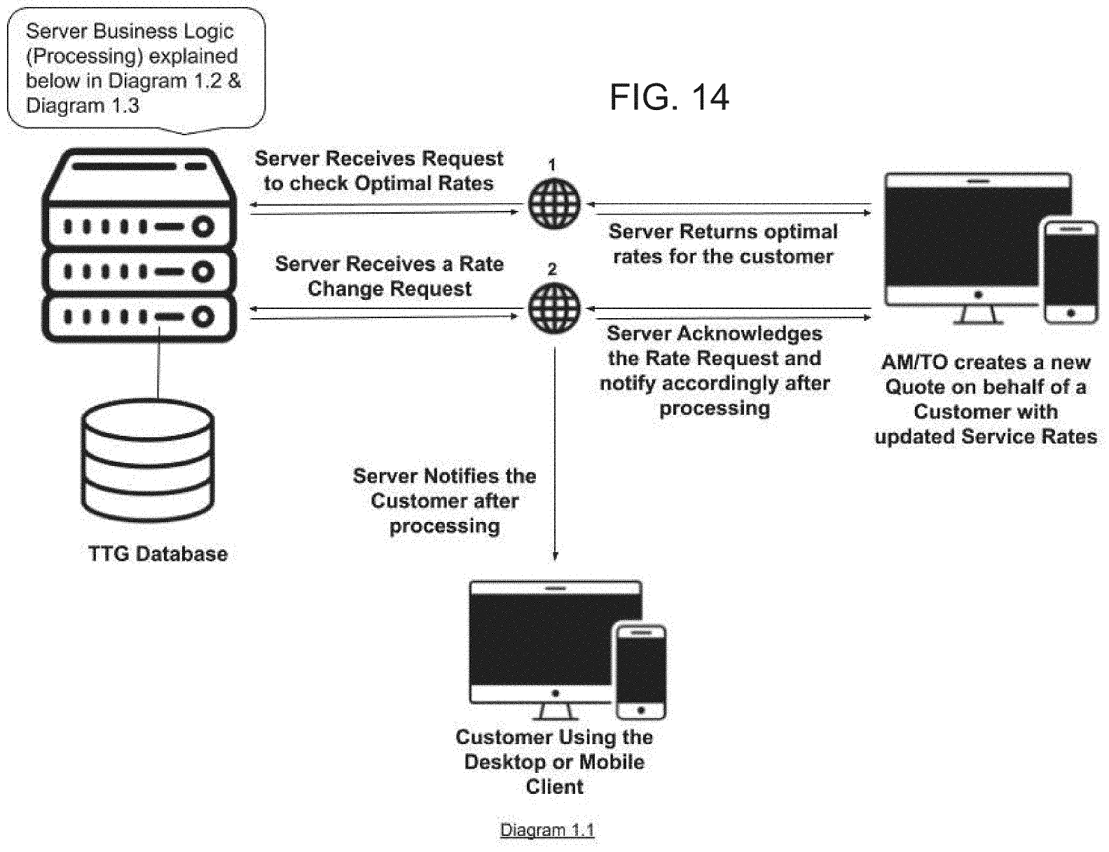

As shown in FIGS. 13 and 14 the system may comprise a central server, the internet, a database, and a plurality of mobile devices. The mobile devices may send a request to check optimal rates to the server via the internet. In some embodiments an account manager and technical owner may send a request on behalf of a customer via the internet to the server to check optimal rates. In turn, the server may return an optimal rate for the customer to the account manager and technical owner. The server may, in some embodiments, receive a rate change request via the internet from the account manager and technical owner mobile devices and in turn the server may notify the customer's mobile device after processing such a request.

### Customer Optimal Rate Machine Learning Model

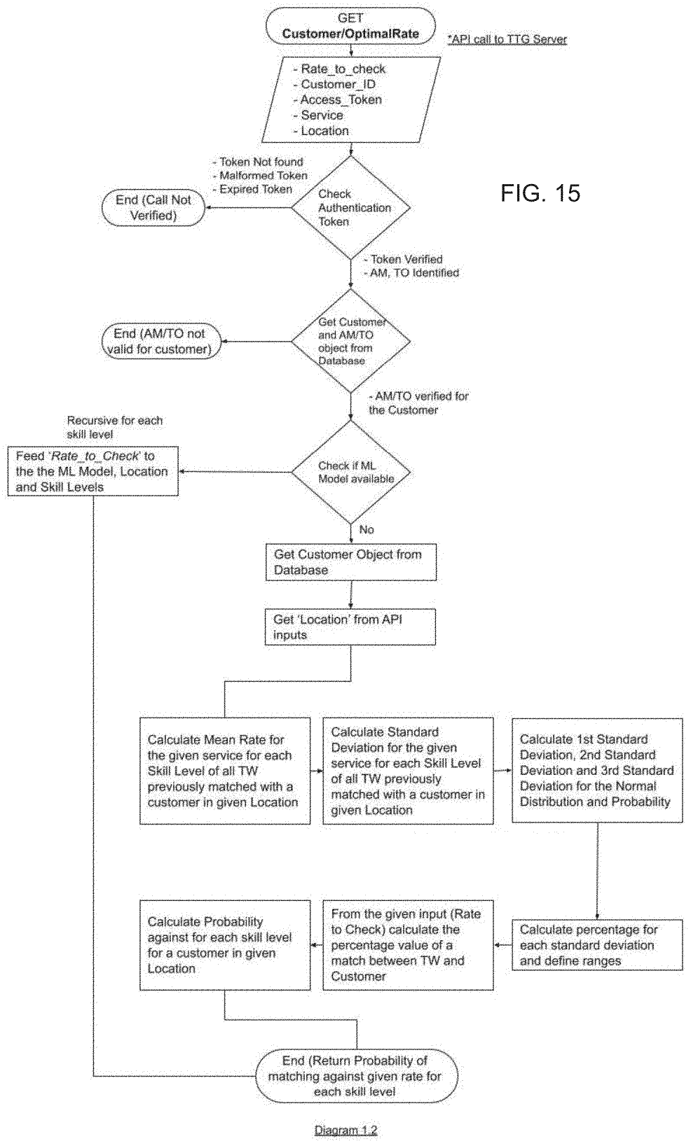

As shown in FIG. 15 the system may have server business logic also known as processing in some embodiments of the present system. The system may have an API call to the server wherein the system sends a get request to determine the optimal rate for a customer. In some embodiments the system may send the get request seeking among other information a rate to check, a customer identifier, an access token, a service that is being requested, and a location.

In some embodiments, as shown in FIG. 15 the server may check the authentication token to determine that a token was not found, the token was malformed, the token was expired, the token was verified, or the account manager and technical owner were identified. In some embodiments, if the system determines that a token was not found, the token was malformed, or the token was expired the system's process may end due to lack of verification. In some embodiments if the token is verified and the account manager and technical owner are identified then the system may get a customer, account manager, and technical owner object from the database.

In some embodiments, as shown in FIG. 15 the system may check to see if the account manager and technical owner are verified for the customer. If the account manager and technical owner are not valid then the system may end its process. If the account manager and technical owner are verified then the system may recursively check if a machine learning model is available based on various skill levels. In some embodiments if the machine learning model is not available the system may retrieve customer object data from a database as well as location data from multiple API inputs.

In some embodiments as shown in FIG. 15 the system may then calculate a mean rate for the given service for each skill level of all technical workers previously matched with a customer in a given location. Then the system may calculate a standard deviation for a given service for each skill level of all technical workers previously matched with a customer in a given location. In some embodiments the system may calculate a first standard deviation, a second standard deviation, and a third standard deviation for a normal distribution and probability. In some embodiments the system may calculate a percentage for each standard deviation and define ranges. In some embodiments, the system may calculate a percentage value of a match between a technical worker and a customer based on a rate to check input. In some embodiments, the system may calculate a probability against each skill level for a customer in a given location. The system may end the server request by returning a probability of matching against a given rate for each skill level.

### Customer Service Rate

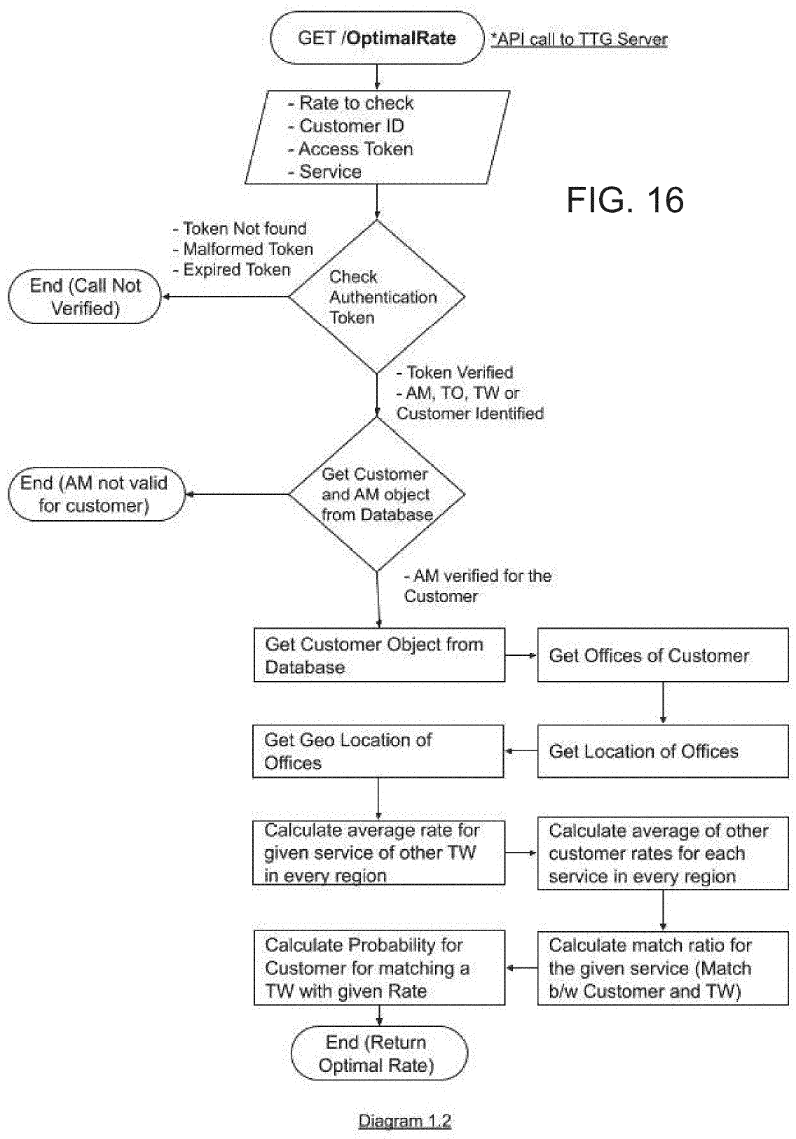

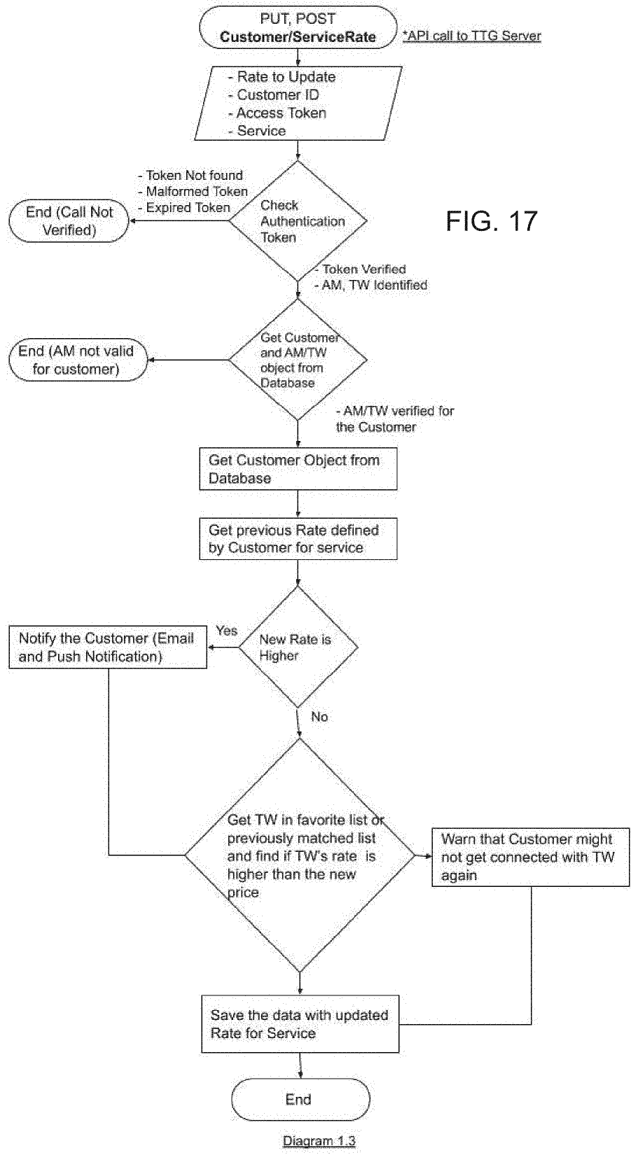

In some embodiments of the present invention as shown in FIG. 16 the system may initiate a call to a server using a rate to update, customer identifier, access token, and service information. In some embodiments, the server may check the authentication token to determine that a token was not found, the token was malformed, the token was expired, the token was verified, or the account manager and technical owner were identified. In some embodiments, if the system determines that a token was not found, the token was malformed, or the token was expired the system's process may end due to lack of verification. In some embodiments if the token is verified and the account manager and technical owner are identified then the system may get a customer, account manager, and technical owner object from the database. In some embodiments the system may retrieve a customer object from a database and then retrieve a previous rate defined by the customer for a service. In some embodiments the system may check to see if a new rate is higher than a previous rate and if it is higher the system may notify the customer via various means such as, for example, email and push notifications. If the new rate is not higher than the previous rate the system may retrieve a technical worker in a favorite list or previously matched list and find out if the technical workers rate is higher than the new rate. In some embodiments, if the technical workers rate was higher than the new rate the system may warn the customer that they may not be connected with a specific technical worker again. In some embodiments if the technical worker's rate is not higher than the new rate the system may save the data with an updated rate for the service.

### Date Pre-Processing and Date Splitting for Feature Extraction

In some embodiments the system may tabulate data for all jobs in the system where a customer may have matched with a technical owner or technical worker. Such data may include, for example, a skill level, a customer rate, a member rate, a geolocation, and a service type. In some embodiments the system may also simultaneously tabulate data for all customers including, for example, required skill levels, customer rates, geolocation of a customer or the customer's office, and the service type. In some embodiments the system may also simultaneously tabulate data for all registered technical owners and technical workers including, for example, an approved skill level, a technical worker or technical owner's rate, a geolocation of a member within a service region using a radius, and a service type. In some embodiments the system may also simultaneously tabulate data for available service regions including, for example, service types and geolocation with a system defined radius. In some embodiments the system may conduct date pre-processing.

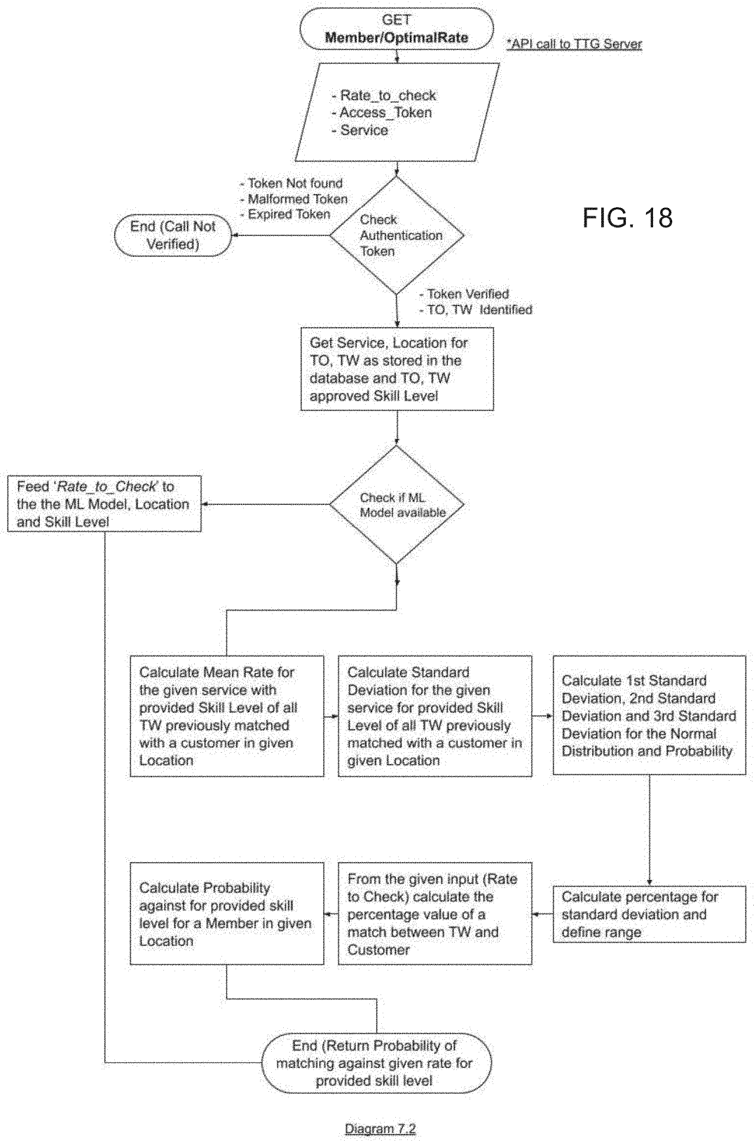

In some embodiments, the system may also conduct date splitting and feature extraction and then execute the machine learning algorithm as described in FIGS. 15 and 18. The machine learning algorithm may then create a predictive model for optimized rates based on a service type, skill level, and location.

### Member Optimal Rate with Machine Learning

In some embodiments, as is shown in FIG. 18 the system may have an API call to the server wherein the system sends a get request to determine the optimal rate for a member. In some embodiments the system may send the get request seeking among other information a rate to check, an access token, and a service that is being requested.

In some embodiments, as shown in FIG. 18 the server may check the authentication token to determine that a token was not found, the token was malformed, the token was expired, the token was verified, or the account manager and technical owner were identified. In some embodiments, if the system determines that a token was not found, the token was malformed, or the token was expired the system's process may end due to lack of verification. In some embodiments if the token is verified and the account manager and technical owner are identified then the system may retreive a service, location for a technical owner and/or technical worker as stored in a database, and a technical owner and/or technical worker approved skill level.

As shown in FIG. 18, in some embodiments, the system may check if a machine learning model is available. If the machine learning model is available, in some embodiments, the system may feed a rate to check to the machine learning model with a location and a skill level. In some embodiments, if the machine learning model is not available the system may retrieve customer object data from a database as well as location data from multiple API inputs.

In some embodiments as shown in FIG. 18 the system may then calculate a mean rate for the given service for each skill level of all technical workers previously matched with a customer in a given location. Then the system may calculate a standard deviation for a given service for each skill level of all technical workers previously matched with a customer in a given location. In some embodiments the system may calculate a first standard deviation, a second standard deviation, and a third standard deviation for a normal distribution and probability. In some embodiments the system may calculate a percentage for each standard deviation and define ranges. In some embodiments, the system may calculate a percentage value of a match between a technical worker and a customer based on a rate to check input. In some embodiments, the system may calculate a probability against each skill level for a member in a given location. The system may end the server request by returning a probability of matching against a given rate for each skill level.

### Member Service Rate

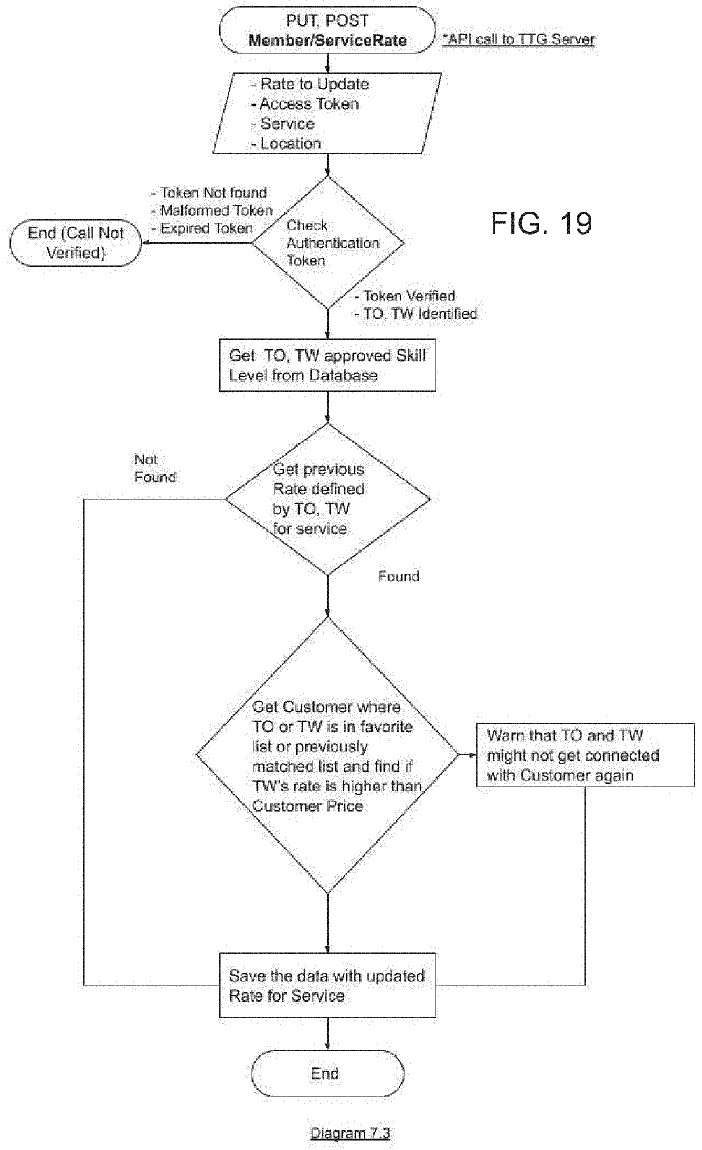

In some embodiments of the present invention as shown in FIG. 19 the system may initiate a call to a server using a rate to update, customer identifier, access token, and service information. In some embodiments, the server may check the authentication token to determine that a token was not found, the token was malformed, the token was expired, the token was verified, or the technical owner and technical worker were identified. In some embodiments, if the system determines that a token was not found, the token was malformed, or the token was expired the system's process may end due to lack of verification. In some embodiments if the token is verified and the technical owner and/or technical worker are identified then the system may get a technical owner and/or technical worker approved skill level from a database.

In some embodiments as shown in FIG. 19, the system may get a previous rate as defined by the technical owner and/or the technical worker for a service. If the previous rate was not found then the system may save the data with an updated rate for service. If the previous rate as defined by the technical owner and/or technical worker was found then the system may, in some embodiments, retrieve customer data where the technical owner and/or technical worker is in a favorite list or previously matched list and find out if the technical worker's rate is higher than the customer price. In some embodiments, the system may warn the customer that the technical owner and/or technical worker may not be connected with the customer again. Finally, in some embodiments, the system may save such data with an updated rate for services to end the process.

The system can take the form of an entirely hardware embodiment, an entirely software embodiment or an embodiment containing both hardware and software elements. In one embodiment, the system is implemented in software, which includes but is not limited to firmware, resident software, microcode, etc.

Furthermore, the system can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium comprise a semiconductor or solid-state memory, magnetic tape, a removable computer diskette, a random access memory (RAM), a read-only memory (ROM), a rigid magnetic disk and an optical disk. Current examples of optical disks comprise compact disk-read only memory (CD-ROM), compact disk-read/write (CD-R/W) and DVD.

A data processing system suitable for storing and/or executing program code comprises at least one processor coupled directly or indirectly to memory elements through a system bus. The memory elements can include local memory employed during actual execution of the program code, bulk storage, and cache memories that provide temporary storage of at least some program code in order to reduce the number of times code is retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Described above, aspects of the present application are embodied in a World Wide Web (“WWW”) or (“Web”) site accessible via the Internet. As is well known to those skilled in the art, the term “Internet” refers to the collection of networks and routers that use the Transmission Control Protocol/Internet Protocol (“TCP/IP”) to communicate with one another. The internet 20 can include a plurality of local area networks (“LANs”) and a wide area network (“WAN”) that are interconnected by routers. The routers are special purpose computers used to interface one LAN or WAN to another. Communication links within the LANs may be wireless, twisted wire pair, coaxial cable, or optical fiber, while communication links between networks may utilize 56 Kbps analog telephone lines, 1 Mbps digital T-1 lines, 45 Mbps T-3 lines or other communications links known to those skilled in the art.

Furthermore, computers and other related electronic devices can be remotely connected to either the LANs or the WAN via a digital communications device, modem and temporary telephone, or a wireless link. It will be appreciated that the internet comprises a vast number of such interconnected networks, computers, and routers.

The Internet has recently seen explosive growth by virtue of its ability to link computers located throughout the world. As the Internet has grown, so has the WWW. As is appreciated by those skilled in the art, the WWW is a vast collection of interconnected or “hypertext” documents written in HTML, or other markup languages, that are electronically stored at or dynamically generated by “WWW sites” or “Web sites” throughout the Internet. Additionally, client-side software programs that communicate over the Web using the TCP/IP protocol are part of the WWW, such as JAVA® applets, instant messaging, e-mail, browser plug-ins, Macromedia Flash, chat and others. Other interactive hypertext environments may include proprietary environments such as those provided in America Online or other online service providers, as well as the “wireless Web” provided by various wireless networking providers, especially those in the cellular phone industry. It will be appreciated that the present application could apply in any such interactive communication environments, however, for purposes of discussion, the Web is used as an exemplary interactive hypertext environment with regard to the present application.

A web site is a server/computer connected to the Internet that has massive storage capabilities for storing hypertext documents and that runs administrative software for handling requests for those stored hypertext documents as well as dynamically generating hypertext documents. Embedded within a hypertext document are a number of hyperlinks, i.e., highlighted portions of text which link the document to another hypertext document possibly stored at a website elsewhere on the Internet. Each hyperlink is assigned a URL that provides the name of the linked document on a server connected to the Internet. Thus, whenever a hypertext document is retrieved from any web server, the document is considered retrieved from the World Wide Web. Known to those skilled in the art, a web server may also include facilities for storing and transmitting application programs, such as application programs written in the JAVA® programming language from Sun Microsystems, for execution on a remote computer. Likewise, a web server may also include facilities for executing scripts and other application programs on the web server itself.

A remote access user may retrieve hypertext documents from the World Wide Web via a web browser program. A web browser, such as Netscape's NAVIGATOR® or Microsoft's Internet Explorer, is a software application program for providing a user interface to the WWW. Upon request from the remote access user via the web browser, the web browser requests the desired hypertext document from the appropriate web server using the URL for the document and the hypertext transport protocol (“HTTP”). HTTP is a higher-level protocol than TCP/IP and is designed specifically for the requirements of the WWW. HTTP runs on top of TCP/IP to transfer hypertext documents and user-supplied form data between server and client computers. The WWW browser may also retrieve programs from the web server, such as JAVA applets, for execution on the client computer. Finally, the WWW browser may include optional software components, called plug-ins, that run specialized functionality within the browser. Covering rates are the rates a Account owner would charge to work on another member's client. These typically are lower than the direct customer rates they charge, though they can be any value.

The algorithm of the present invention can be broken down into 3 components, all of which are required; account owner covering rates, customer rates, and optimal account owner association.

Elements that are relevant in determining the optimal covering rates include but are not limited to: (1) A defined “local” area or proximity; (2) member covering rates per skill; (3) member ratings per skill; (4) customer rates in the local area; and (5) may also consider potential optimal account owner or guru association as filter to enable the onsite dispatch algorithm to match account owners with a desirable company.

Customer rates are rates that an account owner or guru defines for customer he/she “owns”. Members of the platform are paid their desired covering rates when working on a given customer. The onsite dispatch algorithm only matches account owners for work where their covering rate is lower than the customer rate including a minimum margin (can be fixed, percentage based, or determined dynamically).

Elements that are relevant in determining the optimal customer rates include but are not limited to: (1) a defined “local” area or proximity; (2) member covering rates per skill; (3) similar customer profiles and required skills; (4) similar customer rates in the local area; and (5) may also consider potential optimal account owner or guru association as filter to enable the onsite dispatch algorithm to match customers with a desirable account owner or guru.

Customers may “favorite” account owners for purposes defining members which they wish to work with. The product leverages machine learning to determine the optimal account owners to match as favorites for a customer.

This portion of the algorithm relies heavily on machine learning and considers the both the covering rates and customer rates. In addition, however, it considers response time, ticket content, skills sets, industry and a number of other factors that come from all elements of the system to try and determine which customers would most likely to favorite specific account owners or gurus.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

What is claimed is:

1. A system, comprising:
a) a server connected to a network, the server comprising:
i) at least one processor;
ii) a database for storing rate information; and
iii) a memory operatively coupled to the processor, the memory storing program instructions that when executed by the processor, causes the processor to:
1) receive a rate request via the network;
2) determine an optimal rate for a customer depending on whether the customer is a new customer or an existing customer;
3) if the customer is an existing customer then receives an input for a new rate;
4) if the new rate is being raised then the system notifies the existing customer of the rate change via the network;
5) if the new rate is being lowered then the system checks for an at least one impacted member who will no longer match the existing customer based upon the new lower rate;
6) if the new rate is being lowered then the system warns the existing customer about the lower rate.

2. The system of claim 1 wherein, the optimal rate for a customer is determined by a machine learning model.

3. The system of claim 2 wherein, the machine learning model incorporates more than one skill level of a technical worker:
a) wherein the machine learning model calculates:
i) a mean rate for a service for the more than one skill level;
ii) a standard deviation for the service for the more than one skill level;
iii) a first, second, and third standard deviation for a normal distribution and probability;
iv) a percentage for the each of the first, second, and third standard deviation;
v) a percentage value of a match between the technical worker and the customer;
vi) a probability for each of the more than one skill levels for the customer.

4. The system of claim 1 wherein, the account owner may confirm the rate change based upon at least one no longer matching existing customer.

5. A system comprising:
a) a server connected to a network, the server comprising:
i) at least one processor;
ii) a database for storing rate information; and
iii) a memory operatively coupled to the processor, the memory storing program instructions that when executed by the processor, causes the processor to:
1) receive a rate request via the network;
2) determine an optimal rate for a customer depending on whether the customer is a new customer or an existing customer;
3) if the customer is new customer then the system suggests an optimal rate based upon parameters from a preexisting economic model; and
4) if the suggested optimal rate is accepted by an account owner then the rate is set in a database and sent to the new customer via the network.

6. The system of claim 5 wherein the system receives an account owner's manually entered rate and rejects the suggested optimal rate.

7. The system of claim 6 wherein the system determines a likelihood of the members accepting the account owner's manually entered rate.

8. The system of claim 7 wherein the system has the ability to accept or reject the manually entered rate based upon the determination of a likelihood of the members accepting the manually entered rate.

9. A system comprising:
a) a server connected to a network, the server receiving rate requests from members via the network, the server comprising:
i) at least one processor;
ii) a database for storing rate information; and
iii) a memory operatively coupled to the processor, the memory storing program instructions that when executed by the processor, causes the processor to:
1) receive a rate request by a member via the network;
2) determine an optimal rate for a member depending on whether the customer is a new member or an existing member;
3) if the member is an existing member and the rates are being raised by the existing member then the system checks a database to determine whether at least one customer is impacted by the rate being raised;
4) if the at least one customer is impacted by the rate being raised the system warns the at least one customer about the rate being raised;
5) if the member is a new member the system suggests an optimal rate based upon parameters from a preexisting economic model;
6) if the suggested optimal rate is accepted by an the new member then the rate is set in a database.

10. The system of claim 9 wherein, the optimal rate for a customer is determined by a machine learning model.

11. The system of claim 10 wherein, the machine learning model incorporates more than one skill level of a technical worker:
a) wherein the machine learning model calculates:
i) a mean rate for a service for the more than one skill level;
ii) a standard deviation for the service for the more than one skill level;
iii) a first, second, and third standard deviation for a normal distribution and probability;
iv) a percentage for the each of the first, second, and third standard deviation;
v) a percentage value of a match between the technical worker and the customer;
vi) a probability for each of the more than one skill levels for the member.

12. The system of claim 11 wherein, the system receives a manually entered rate rejecting the suggested optimal rate.

13. The system of claim 12 wherein, the system determines a likelihood of an at least one customer matching the manually entered rate.

14. The system of claim 13 wherein, the system has the ability to accept or reject the manually entered rate based upon the determination of a likelihood of the at least one customer accepting the manually entered rate.
